(19) United States
(12) Patent Application Publication
(10) Pub. No.: US 2024/0357455 A1
(43) Pub. Date: Oct. 24, 2024

(54) AERIAL NODE LOCATION ADJUSTMENT USING ANGULAR-SPECIFIC SIGNALING

(71) Applicant: Huawei Technologies Co., Ltd., Shenzhen (CN)

(72) Inventors: Jalal Khamse Ashari, Stittsville (CA); Amine Maaref, Ottawa (CA)

(21) Appl. No.: 18/750,614

(22) Filed: Jun. 21, 2024

Related U.S. Application Data
(63) Continuation of application No. PCT/CN2021/141227, filed on Dec. 24, 2021.

(51) Int. Cl. H04W 36/08; H04B 7/06; H04W 36/30; H04W 36/32

(52) U.S. Cl. CPC H04W 36/085; H04B 7/0617; H04W 36/30; H04W 36/324

(57) ABSTRACT

A beam alignment direction for a beam defined between a transmitter and a receiver can be adjusted by causing adjustments in the location (in altitude, in two-dimensional coordinates, or in both) of one or both of the transmitter and the receiver, where the adjustment in the location is carried out at whichever node among the transmitter and the receiver is an aerial node. In case it is determined that the beam alignment direction cannot be maintained in a desired range, a transmit receive point switching may be triggered before a beam failure happens.

### CROSS-REFERENCE TO RELATED APPLICATIONS

This application is a continuation of PCT Application No. PCT/CN2021/141227, entitled “AERIAL NODE LOCATION ADJUSTMENT USING ANGULAR-SPECIFIC SIGNALING,” filed on Dec. 24, 2021, which application is hereby incorporated herein by reference in its entirety.

### TECHNICAL FIELD

The present disclosure relates, generally, to aerial node location adjustment and, in particular embodiments, to carrying out the location adjustment using angular-specific signaling.

### BACKGROUND

Modern cellular systems are known to be considered to comply with a fifth generation (5G) of wireless communication standards. The term “new radio (NR)” is used to reference an air interface portion of the 5G standard. NR is designed to be the global standard for the air interface of 5G networks.

Cellular systems are known to have at least two types of nodes: transmit/receive point (TRP) nodes; and user equipment (UE) nodes. The current NR standard has been developed based on an underlying assumption that the TRP nodes are fixed in their position.

Integrating aerial TRP nodes into next generation wireless communication systems may be shown to introduce some degrees of freedom. One example degree of freedom is a flexibility to adjust a location of an aerial TRP node.

### SUMMARY

Aspects of the present application relate to adjusting a beam alignment direction for a beam defined between a transmitter and a receiver by causing adjustments in the location (in altitude, in two-dimensional coordinates, or in both) of one or both of the transmitter and the receiver, where the adjustment in the location is carried out at whichever node among the transmitter and the receiver is an aerial node.

In the current state of the art, the relative position of the TRP and the UE and, thus, the direction of the beam alignment direction, can be updated only by switching the TRP. Such TRP switching is typically carried out responsive to the UE experiencing a so-called beam failure.

Aspects of the present application relate to changing the relative position of the TRP and the UE by causing adjustments in the location of one or both of the TRP and the UE. A beamforming gain and the resulting signal-to-interference-and-noise-ratio (SINR) may be shown to vary as a position of a transmitter changes relative to a position of a receiver in a certain environment. Indeed, for nodes with common antenna array structures, the beamforming gain/directionality may not be the same in all the directions.

The interference to/from aerial nodes from/to terrestrial nodes may be mitigated by configuring the aerial nodes to maintain an elevation/azimuth angle in a particular range, defined by a minimum and a maximum.

Based on aspects of the present application, the flexibility of location for aerial nodes may be exploited while respecting a minimum elevation angle so as to alleviate a known Remote Interference Problem.

Aspects of the present application allow for increasing spatial multiplexing gain and beamforming gain/directionality by adjusting the location of aerial nodes, with consequences such as improvements in SINR. The chance for a given UE to experience a beam failure may be reduced by proactively adjusting the relative position of an aerial TRP and the UE. In case it is determined that the beam alignment direction cannot be maintained in a desired range, a TRP switching may be triggered before a beam failure happens.

Using angular-specific measurements included in feedback from the UE, the flexibility of deploying aerial TRPs may be exploited to enhance spatial multiplexing gain while minimizing co-channel interference that is observed at the UE.

According to an aspect of the present disclosure, there is provided a method of causing updating of a location of an aerial node so as to maintain a desired beam alignment direction. The method includes receiving, at the aerial node from a first communication device, information that is specific to the first communication device, adjusting a location of the aerial node to a new location that has been determined based, at least in part, on the received information and transmitting, to the first communication device, an indication of a new beam alignment direction, wherein the new beam alignment direction has been determined based on the new location of the aerial node.

According to an aspect of the present disclosure, there is provided a method of configuring a first communication device. The method includes receiving, from the first communication device, information that is specific to the first communication device and transmitting, to the first communication device, an angular-specific configuration determined on the basis of the information.

According to an aspect of the present disclosure, there is provided a method of maintaining a communication channel associated with a beam alignment direction. The method includes receiving, at an aerial communication device, configuration information including an indication of a range of angles for an angle of the beam alignment direction and self-adjusting a location for the aerial communication device, the self-adjusting based on maintaining the beam alignment direction within the range of angles.

According to an aspect of the present disclosure, there is provided a method of handling an increase in demand for transmit receive point services. The method includes receiving information from a plurality of communication devices connected to certain transmit receive points and transmitting, to a deployed non-terrestrial transmit receive point, an indication of a determined new location, wherein determining the new location uses the information received from the communication devices.

### BRIEF DESCRIPTION OF THE DRAWINGS

For a more complete understanding of the present embodiments, and the advantages thereof, reference is now made, by way of example, to the following descriptions taken in conjunction with the accompanying drawings, in which:

FIG. 1 illustrates, in a schematic diagram, a communication system in which embodiments of the disclosure may occur, the communication system includes multiple example electronic devices and multiple example transmit receive points along with various networks;

FIG. 2 illustrates, in a block diagram, the communication system of FIG. 1, the communication system includes multiple example electronic devices, an example terrestrial transmit receive point and an example non-terrestrial transmit receive point along with various networks;

FIG. 3 illustrates, as a block diagram, elements of an example electronic device of FIG. 2, elements of an example terrestrial transmit receive point of FIG. 2 and elements of an example non-terrestrial transmit receive point of FIG. 2, in accordance with aspects of the present application;

FIG. 4 illustrates, as a block diagram, various modules that may be included in an example electronic device, an example terrestrial transmit receive point and an example non-terrestrial transmit receive point, in accordance with aspects of the present application;

FIG. 5 illustrates, as a block diagram, a sensing management function, in accordance with aspects of the present application;

FIG. 6 illustrates elements of FIG. 2 with some additional elements: a central radio access network unit; and a base band unit, in accordance with aspects of the present application;

FIG. 7 illustrates elements of FIG. 2 with some additional elements in the form of a base band unit included in each transmit receive point of FIG. 2, in accordance with aspects of the present application;

FIG. 8 illustrates a scenario including multiple transmit receive points and an aerial UE, with the transmit receive points being associated with respective ranges of available beam alignment directions, in accordance with aspects of the present application;

FIG. 9 illustrates a signal flow among the elements of FIG. 8, in accordance with aspects of the present application;

FIG. 10 illustrates a scenario including multiple terrestrial transmit receive points and an aerial UE, with the transmit receive points being associated with beam alignment directions, in accordance with aspects of the present application;

FIG. 11 illustrates example steps in a method, carried out at a UE, of causing changes in beam alignment direction, in accordance with aspects of the present application;

FIG. 12 illustrates examples steps in a method, carried out at a particular aerial transmit receive point, of implementing changes in beam alignment direction, in accordance with aspects of the present application;

FIG. 13 illustrates example steps in a method of handling, at a base band unit, an increase in demand for transmit receive point services using on-demand deployment of an aerial transmit receive point, in accordance with aspects of the present application; and

FIG. 14 illustrates example steps in a method of handing an increase in demand for transmit receive point services as an alternative to the method illustrated in FIG. 13, in accordance with aspects of the present application.

### DETAILED DESCRIPTION OF THE EMBODIMENTS

For illustrative purposes, specific example embodiments will now be explained in greater detail in conjunction with the figures.

The embodiments set forth herein represent information sufficient to practice the claimed subject matter and illustrate ways of practicing such subject matter. Upon reading the following description in light of the accompanying figures, those of skill in the art will understand the concepts of the claimed subject matter and will recognize applications of these concepts not particularly addressed herein. It should be understood that these concepts and applications fall within the scope of the disclosure and the accompanying claims.

Moreover, it will be appreciated that any module, component, or device disclosed herein that executes instructions may include, or otherwise have access to, a non-transitory computer/processor readable storage medium or media for storage of information, such as computer/processor readable instructions, data structures, program modules and/or other data. A non-exhaustive list of examples of non-transitory computer/processor readable storage media includes magnetic cassettes, magnetic tape, magnetic disk storage or other magnetic storage devices, optical disks such as compact disc read-only memory (CD-ROM), digital video discs or digital versatile discs (i.e., DVDs), Blu-ray Disc™, or other optical storage, volatile and non-volatile, removable and non-removable media implemented in any method or technology, random-access memory (RAM), read-only memory (ROM), electrically erasable programmable read-only memory (EEPROM), flash memory or other memory technology. Any such non-transitory computer/processor storage media may be part of a device or accessible or connectable thereto. Computer/processor readable/executable instructions to implement an application or module described herein may be stored or otherwise held by such non-transitory computer/processor readable storage media.

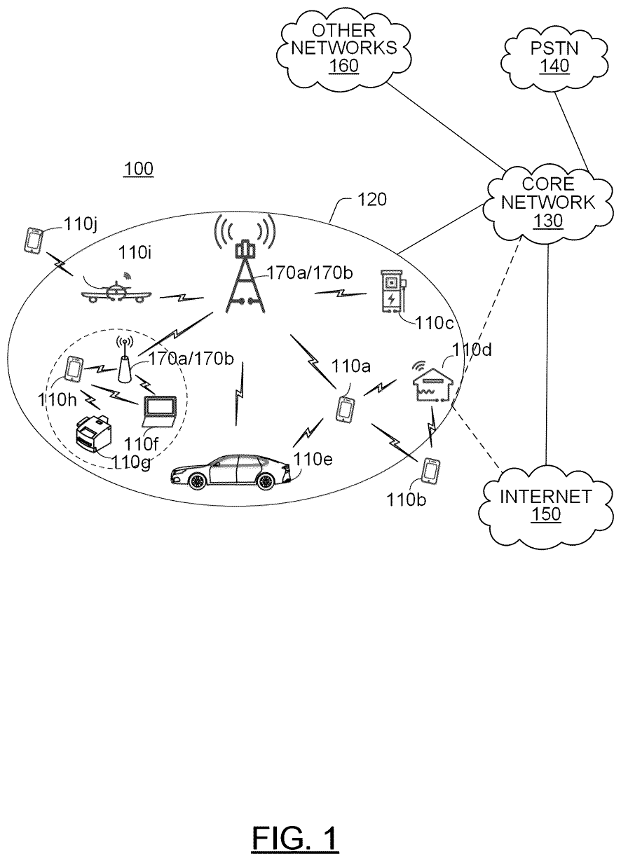

Referring to FIG. 1, as an illustrative example without limitation, a simplified schematic illustration of a communication system is provided. The communication system 100 comprises a radio access network 120. The radio access network 120 may be a next generation (e.g., sixth generation, “6G,” or later) radio access network, or a legacy (e.g., 5G, 4G, 3G or 2G) radio access network. One or more communication electric device (ED) 110a, 110b, 110c, 110d, 110e, 110f, 110g, 110h, 110i, 110j (generically referred to as 110) may be interconnected to one another or connected to one or more network nodes (170a, 170b, generically referred to as 170) in the radio access network 120. A core network 130 may be a part of the communication system and may be dependent or independent of the radio access technology used in the communication system 100. Also the communication system 100 comprises a public switched telephone network (PSTN) 140, the internet 150, and other networks 160.

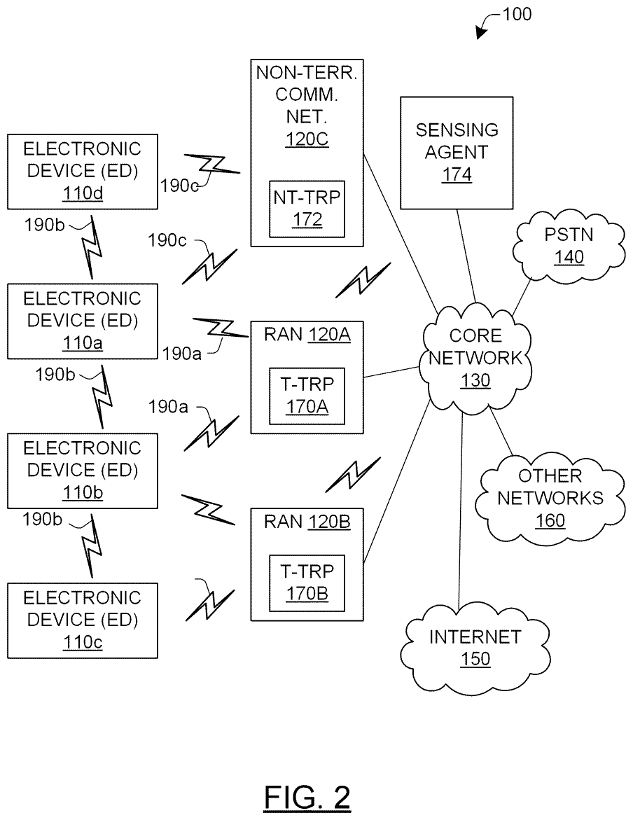

FIG. 2 illustrates an example communication system 100. In general, the communication system 100 enables multiple wireless or wired elements to communicate data and other content. The purpose of the communication system 100 may be to provide content, such as voice, data, video, and/or text, via broadcast, multicast and unicast, etc. The communication system 100 may operate by sharing resources, such as carrier spectrum bandwidth, between its constituent elements. The communication system 100 may include a terrestrial communication system and/or a non-terrestrial communication system. The communication system 100 may provide a wide range of communication services and applications (such as earth monitoring, remote sensing, passive sensing and positioning, navigation and tracking, autonomous delivery and mobility, etc.). The communication system 100 may provide a high degree of availability and robustness through a joint operation of a terrestrial communication system and a non-terrestrial communication system. For example, integrating a non-terrestrial communication system (or components thereof) into a terrestrial communication system can result in what may be considered a heterogeneous network comprising multiple layers. Compared to conventional communication networks, the heterogeneous network may achieve better overall performance through efficient multi-link joint operation, more flexible functionality sharing and faster physical layer link switching between terrestrial networks and non-terrestrial networks.

The terrestrial communication system and the non-terrestrial communication system could be considered sub-systems of the communication system. In the example shown in FIG. 2, the communication system 100 includes electronic devices (ED) 110a, 110b, 110c, 110d (generically referred to as ED 110), radio access networks (RANs) 120a, 120b, a non-terrestrial communication network 120c, a core network 130, a public switched telephone network (PSTN) 140, the Internet 150 and other networks 160. The RANs 120a, 120b include respective base stations (BSs) 170a, 170b, which may be generically referred to as terrestrial transmit and receive points (T-TRPs) 170a, 170b. The non-terrestrial communication network 120c includes an access node 172, which may be generically referred to as a non-terrestrial transmit and receive point (NT-TRP) 172.

Any ED 110 may be alternatively or additionally configured to interface, access, or communicate with any T-TRP 170a, 170b and NT-TRP 172, the Internet 150, the core network 130, the PSTN 140, the other networks 160, or any combination of the preceding. In some examples, the ED 110a may communicate an uplink and/or downlink transmission over a terrestrial air interface 190a with T-TRP 170a. In some examples, the EDs 110a, 110b, 110c and 110d may also communicate directly with one another via one or more sidelink air interfaces 190b. In some examples, the ED 110d may communicate an uplink and/or downlink transmission over a non-terrestrial air interface 190c with NT-TRP 172.

The air interfaces 190a and 190b may use similar communication technology, such as any suitable radio access technology. For example, the communication system 100 may implement one or more channel access methods, such as code division multiple access (CDMA), space division multiple access (SDMA), time division multiple access (TDMA), frequency division multiple access (FDMA), orthogonal FDMA (OFDMA), or single-carrier FDMA (SC-FDMA) in the air interfaces 190a and 190b. The air interfaces 190a and 190b may utilize other higher dimension signal spaces, which may involve a combination of orthogonal and/or non-orthogonal dimensions.

The non-terrestrial air interface 1900 can enable communication between the ED 110d and one or multiple NT-TRPs 172 via a wireless link or simply a link. For some examples, the link is a dedicated connection for unicast transmission, a connection for broadcast transmission, or a connection between a group of EDs 110 and one or multiple NT-TRPs 175 for multicast transmission.

The RANs 120a and 120b are in communication with the core network 130 to provide the EDs 110a, 110b, 110c with various services such as voice, data and other services. The RANs 120a and 120b and/or the core network 130 may be in direct or indirect communication with one or more other RANs (not shown), which may or may not be directly served by core network 130 and may, or may not, employ the same radio access technology as RAN 120a, RAN 120b or both. The core network 130 may also serve as a gateway access between (i) the RANs 120a and 120b or the EDs 110a, 110b, 110c or both, and (ii) other networks (such as the PSTN 140, the Internet 150, and the other networks 160). In addition, some or all of the EDs 110a, 110b, 110c may include functionality for communicating with different wireless networks over different wireless links using different wireless technologies and/or protocols. Instead of wireless communication (or in addition thereto), the EDs 110a, 110b, 110c may communicate via wired communication channels to a service provider or switch (not shown) and to the Internet 150. The PSTN 140 may include circuit switched telephone networks for providing plain old telephone service (POTS). The Internet 150 may include a network of computers and subnets (intranets) or both and incorporate protocols, such as Internet Protocol (IP), Transmission Control Protocol (TCP), User Datagram Protocol (UDP). The EDs 110a, 110b, 110c may be multimode devices capable of operation according to multiple radio access technologies and may incorporate multiple transceivers necessary to support such.

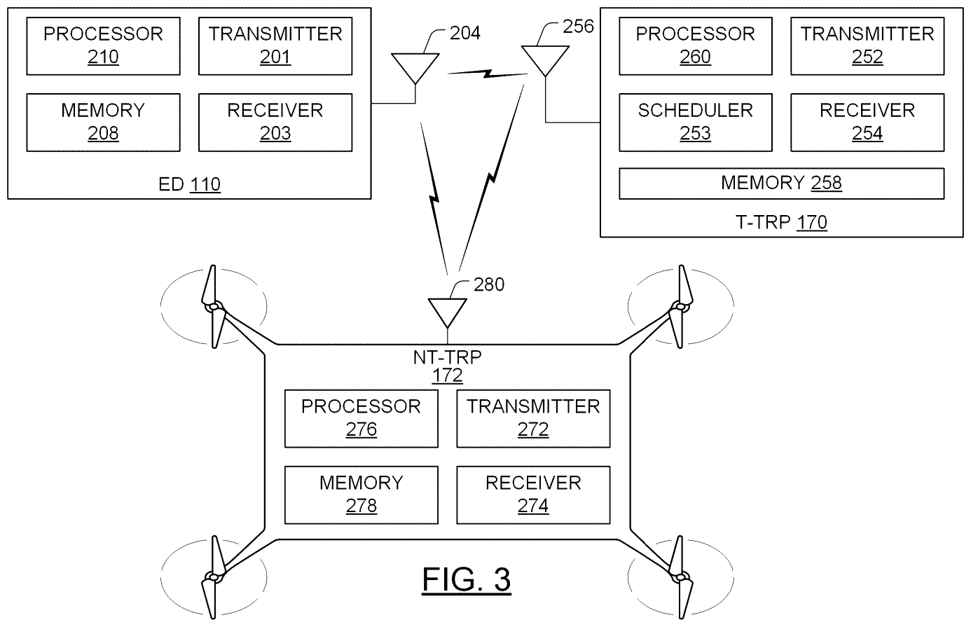

FIG. 3 illustrates another example of an ED 110 and a base station 170a, 170b and/or 170c. The ED 110 is used to connect persons, objects, machines, etc. The ED 110 may be widely used in various scenarios, for example, cellular communications, device-to-device (D2D), vehicle to everything (V2X), peer-to-peer (P2P), machine-to-machine (M2M), machine-type communications (MTC), Internet of things (IOT), virtual reality (VR), augmented reality (AR), industrial control, self-driving, remote medical, smart grid, smart furniture, smart office, smart wearable, smart transportation, smart city, drones, robots, remote sensing, passive sensing, positioning, navigation and tracking, autonomous delivery and mobility, etc.

Each ED 110 represents any suitable end user device for wireless operation and may include such devices (or may be referred to) as a user equipment/device (UE), a wireless transmit/receive unit (WTRU), a mobile station, a fixed or mobile subscriber unit, a cellular telephone, a station (STA), a machine type communication (MTC) device, a personal digital assistant (PDA), a smartphone, a laptop, a computer, a tablet, a wireless sensor, a consumer electronics device, a smart book, a vehicle, a car, a truck, a bus, a train, or an IoT device, an industrial device, or apparatus (e.g., communication module, modem, or chip) in the forgoing devices, among other possibilities. Future generation EDs 110 may be referred to using other terms. The base stations 170a and 170b each T-TRPs and will, hereafter, be referred to as T-TRP 170. Also shown in FIG. 3, a NT-TRP will hereafter be referred to as NT-TRP 172. Each ED 110 connected to the T-TRP 170 and/or the NT-TRP 172 can be dynamically or semi-statically turned-on (i.e., established, activated or enabled), turned-off (i.e., released, deactivated or disabled) and/or configured in response to one of more of: connection availability; and connection necessity.

The ED 110 includes a transmitter 201 and a receiver 203 coupled to one or more antennas 204. Only one antenna 204 is illustrated. One, some, or all of the antennas 204 may, alternatively, be panels. The transmitter 201 and the receiver 203 may be integrated, e.g., as a transceiver. The transceiver is configured to modulate data or other content for transmission by the at least one antenna 204 or by a network interface controller (NIC). The transceiver may also be configured to demodulate data or other content received by the at least one antenna 204. Each transceiver includes any suitable structure for generating signals for wireless or wired transmission and/or processing signals received wirelessly or by wire. Each antenna 204 includes any suitable structure for transmitting and/or receiving wireless or wired signals.

The ED 110 includes at least one memory 208. The memory 208 stores instructions and data used, generated, or collected by the ED 110. For example, the memory 208 could store software instructions or modules configured to implement some or all of the functionality and/or embodiments described herein and that are executed by one or more processing unit(s) (e.g., a processor 210). Each memory 208 includes any suitable volatile and/or non-volatile storage and retrieval device(s). Any suitable type of memory may be used, such as random access memory (RAM), read only memory (ROM), hard disk, optical disc, subscriber identity module (SIM) card, memory stick, secure digital (SD) memory card, on-processor cache and the like.

The ED 110 may further include one or more input/output devices (not shown) or interfaces (such as a wired interface to the Internet 150 in FIG. 1). The input/output devices permit interaction with a user or other devices in the network. Each input/output device includes any suitable structure for providing information to, or receiving information from, a user, such as through operation as a speaker, a microphone, a keypad, a keyboard, a display or a touch screen, including network interface communications.

The ED 110 includes the processor 210 for performing operations including those operations related to preparing a transmission for uplink transmission to the NT-TRP 172 and/or the T-TRP 170, those operations related to processing downlink transmissions received from the NT-TRP 172 and/or the T-TRP 170, and those operations related to processing sidelink transmission to and from another ED 110. Processing operations related to preparing a transmission for uplink transmission may include operations such as encoding, modulating, transmit beamforming and generating symbols for transmission. Processing operations related to processing downlink transmissions may include operations such as receive beamforming, demodulating and decoding received symbols. Depending upon the embodiment, a downlink transmission may be received by the receiver 203, possibly using receive beamforming, and the processor 210 may extract signaling from the downlink transmission (e.g., by detecting and/or decoding the signaling). An example of signaling may be a reference signal transmitted by the NT-TRP 172 and/or by the T-TRP 170. In some embodiments, the processor 210 implements the transmit beamforming and/or the receive beamforming based on the indication of beam direction, e.g., beam angle information (BAI), received from the T-TRP 170. In some embodiments, the processor 210 may perform operations relating to network access (e.g., initial access) and/or downlink synchronization, such as operations relating to detecting a synchronization sequence, decoding and obtaining the system information, etc. In some embodiments, the processor 210 may perform channel estimation, e.g., using a reference signal received from the NT-TRP 172 and/or from the T-TRP 170.

Although not illustrated, the processor 210 may form part of the transmitter 201 and/or part of the receiver 203. Although not illustrated, the memory 208 may form part of the processor 210.

The processor 210, the processing components of the transmitter 201 and the processing components of the receiver 203 may each be implemented by the same or different one or more processors that are configured to execute instructions stored in a memory (e.g., the in memory 208). Alternatively, some or all of the processor 210, the processing components of the transmitter 201 and the processing components of the receiver 203 may each be implemented using dedicated circuitry, such as a programmed field-programmable gate array (FPGA), a graphical processing unit (GPU), or an application-specific integrated circuit (ASIC).

The T-TRP 170 may be known by other names in some implementations, such as a base station, a base transceiver station (BTS), a radio base station, a network node, a network device, a device on the network side, a transmit/receive node, a Node B, an evolved NodeB (eNodeB or eNB), a Home eNodeB, a next Generation NodeB (gNB), a transmission point (TP), a site controller, an access point (AP), a wireless router, a relay station, a remote radio head, a terrestrial node, a terrestrial network device, a terrestrial base station, a base band unit (BBU), a remote radio unit (RRU), an active antenna unit (AAU), a remote radio head (RRH), a central unit (CU), a distribute unit (DU), a positioning node, among other possibilities. The T-TRP 170 may be a macro BS, a pico BS, a relay node, a donor node, or the like, or combinations thereof. The T-TRP 170 may refer to the forgoing devices or refer to apparatus (e.g., a communication module, a modem or a chip) in the forgoing devices.

In some embodiments, the parts of the T-TRP 170 may be distributed. For example, some of the modules of the T-TRP 170 may be located remote from the equipment that houses antennas 256 for the T-TRP 170, and may be coupled to the equipment that houses antennas 256 over a communication link (not shown) sometimes known as front haul, such as common public radio interface (CPRI). Therefore, in some embodiments, the term T-TRP 170 may also refer to modules on the network side that perform processing operations, such as determining the location of the ED 110, resource allocation (scheduling), message generation, and encoding/decoding, and that are not necessarily part of the equipment that houses antennas 256 of the T-TRP 170. The modules may also be coupled to other T-TRPs. In some embodiments, the T-TRP 170 may actually be a plurality of T-TRPs that are operating together to serve the ED 110, e.g., through the use of coordinated multipoint transmissions.

As illustrated in FIG. 3, the T-TRP 170 includes at least one transmitter 252 and at least one receiver 254 coupled to one or more antennas 256. Only one antenna 256 is illustrated. One, some, or all of the antennas 256 may, alternatively, be panels. The transmitter 252 and the receiver 254 may be integrated as a transceiver. The T-TRP 170 further includes a processor 260 for performing operations including those related to: preparing a transmission for downlink transmission to the ED 110; processing an uplink transmission received from the ED 110; preparing a transmission for backhaul transmission to the NT-TRP 172; and processing a transmission received over backhaul from the NT-TRP 172. Processing operations related to preparing a transmission for downlink or backhaul transmission may include operations such as encoding, modulating, precoding (e.g., multiple input multiple output, “MIMO,” precoding), transmit beamforming and generating symbols for transmission. Processing operations related to processing received transmissions in the uplink or over backhaul may include operations such as receive beamforming, demodulating received symbols and decoding received symbols. The processor 260 may also perform operations relating to network access (e.g., initial access) and/or downlink synchronization, such as generating the content of synchronization signal blocks (SSBs), generating the system information, etc. In some embodiments, the processor 260 also generates an indication of beam direction, e.g., BAI, which may be scheduled for transmission by a scheduler 253. The processor 260 performs other network-side processing operations described herein, such as determining the location of the ED 110, determining where to deploy the NT-TRP 172, etc. In some embodiments, the processor 260 may generate signaling, e.g., to configure one or more parameters of the ED 110 and/or one or more parameters of the NT-TRP 172. Any signaling generated by the processor 260 is sent by the transmitter 252. Note that “signaling,” as used herein, may alternatively be called control signaling. Dynamic signaling may be transmitted in a control channel, e.g., a physical downlink control channel (PDCCH) and static, or semi-static, higher layer signaling may be included in a packet transmitted in a data channel, e.g., in a physical downlink shared channel (PDSCH).

The scheduler 253 may be coupled to the processor 260. The scheduler 253 may be included within, or operated separately from, the T-TRP 170. The scheduler 253 may schedule uplink, downlink and/or backhaul transmissions, including issuing scheduling grants and/or configuring scheduling-free (“configured grant”) resources. The T-TRP 170 further includes a memory 258 for storing information and data. The memory 258 stores instructions and data used, generated, or collected by the T-TRP 170. For example, the memory 258 could store software instructions or modules configured to implement some or all of the functionality and/or embodiments described herein and that are executed by the processor 260.

Although not illustrated, the processor 260 may form part of the transmitter 252 and/or part of the receiver 254. Also, although not illustrated, the processor 260 may implement the scheduler 253. Although not illustrated, the memory 258 may form part of the processor 260.

The processor 260, the scheduler 253, the processing components of the transmitter 252 and the processing components of the receiver 254 may each be implemented by the same, or different one of, one or more processors that are configured to execute instructions stored in a memory, e.g., in the memory 258. Alternatively, some or all of the processor 260, the scheduler 253, the processing components of the transmitter 252 and the processing components of the receiver 254 may be implemented using dedicated circuitry, such as a FPGA, a GPU or an ASIC.

Notably, the NT-TRP 172 is illustrated as a drone only as an example, the NT-TRP 172 may be implemented in any suitable non-terrestrial form. Also, the NT-TRP 172 may be known by other names in some implementations, such as a non-terrestrial node, a non-terrestrial network device, or a non-terrestrial base station. The NT-TRP 172 includes a transmitter 272 and a receiver 274 coupled to one or more antennas 280. Only one antenna 280 is illustrated. One, some, or all of the antennas may alternatively be panels. The transmitter 272 and the receiver 274 may be integrated as a transceiver. The NT-TRP 172 further includes a processor 276 for performing operations including those related to: preparing a transmission for downlink transmission to the ED 110; processing an uplink transmission received from the ED 110; preparing a transmission for backhaul transmission to T-TRP 170; and processing a transmission received over backhaul from the T-TRP 170. Processing operations related to preparing a transmission for downlink or backhaul transmission may include operations such as encoding, modulating, precoding (e.g., MIMO precoding), transmit beamforming and generating symbols for transmission. Processing operations related to processing received transmissions in the uplink or over backhaul may include operations such as receive beamforming, demodulating received signals and decoding received symbols. In some embodiments, the processor 276 implements the transmit beamforming and/or receive beamforming based on beam direction information (e.g., BAI) received from the T-TRP 170. In some embodiments, the processor 276 may generate signaling, e.g., to configure one or more parameters of the ED 110. In some embodiments, the NT-TRP 172 implements physical layer processing but does not implement higher layer functions such as functions at the medium access control (MAC) or radio link control (RLC) layer. As this is only an example, more generally, the NT-TRP 172 may implement higher layer functions in addition to physical layer processing.

The NT-TRP 172 further includes a memory 278 for storing information and data. Although not illustrated, the processor 276 may form part of the transmitter 272 and/or part of the receiver 274. Although not illustrated, the memory 278 may form part of the processor 276.

The processor 276, the processing components of the transmitter 272 and the processing components of the receiver 274 may each be implemented by the same or different one or more processors that are configured to execute instructions stored in a memory, e.g., in the memory 278. Alternatively, some or all of the processor 276, the processing components of the transmitter 272 and the processing components of the receiver 274 may be implemented using dedicated circuitry, such as a programmed FPGA, a GPU or an ASIC. In some embodiments, the NT-TRP 172 may actually be a plurality of NT-TRPs that are operating together to serve the ED 110, e.g., through coordinated multipoint transmissions.

The T-TRP 170, the NT-TRP 172, and/or the ED 110 may include other components, but these have been omitted for the sake of clarity.

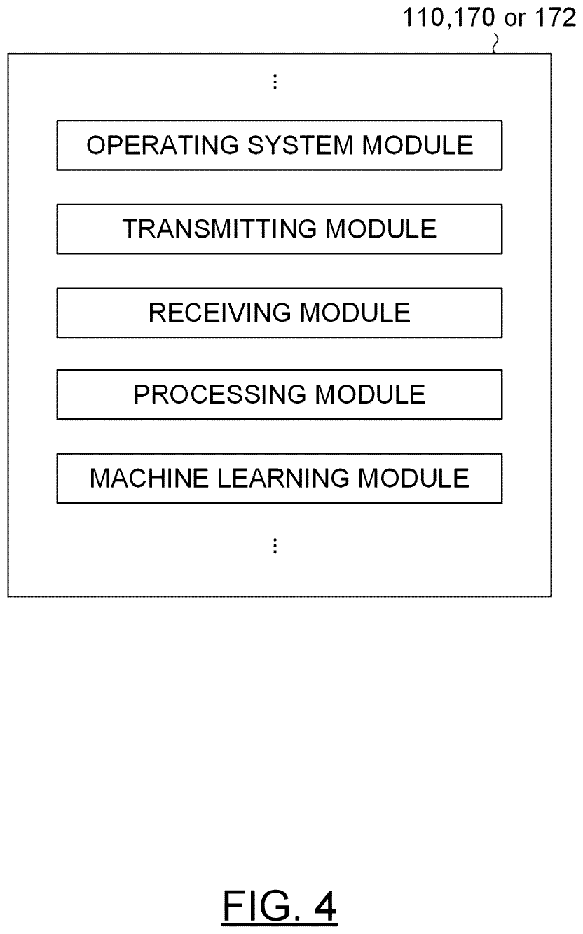

One or more steps of the embodiment methods provided herein may be performed by corresponding units or modules, according to FIG. 4. FIG. 4 illustrates units or modules in a device, such as in the ED 110, in the T-TRP 170 or in the NT-TRP 172. For example, a signal may be transmitted by a transmitting unit or by a transmitting module. A signal may be received by a receiving unit or by a receiving module. A signal may be processed by a processing unit or a processing module. Other steps may be performed by an artificial intelligence (AI) or machine learning (ML) module. The respective units or modules may be implemented using hardware, one or more components or devices that execute software, or a combination thereof. For instance, one or more of the units or modules may be an integrated circuit, such as a programmed FPGA, a GPU or an ASIC. It will be appreciated that where the modules are implemented using software for execution by a processor, for example, the modules may be retrieved by a processor, in whole or part as needed, individually or together for processing, in single or multiple instances, and that the modules themselves may include instructions for further deployment and instantiation.

Additional details regarding the EDs 110, the T-TRP 170 and the NT-TRP 172 are known to those of skill in the art. As such, these details are omitted here.

An air interface generally includes a number of components and associated parameters that collectively specify how a transmission is to be sent and/or received over a wireless communications link between two or more communicating devices. For example, an air interface may include one or more components defining the waveform(s), frame structure(s), multiple access scheme(s), protocol(s), coding scheme(s) and/or modulation scheme(s) for conveying information (e.g., data) over a wireless communications link. The wireless communications link may support a link between a radio access network and user equipment (e.g., a “Uu” link), and/or the wireless communications link may support a link between device and device, such as between two user equipments (e.g., a “sidelink”), and/or the wireless communications link may support a link between a non-terrestrial (NT)-communication network and user equipment (UE). The following are some examples for the above components.

A waveform component may specify a shape and form of a signal being transmitted. Waveform options may include orthogonal multiple access waveforms and non-orthogonal multiple access waveforms. Non-limiting examples of such waveform options include Orthogonal Frequency Division Multiplexing (OFDM), Filtered OFDM (f-OFDM), Time windowing OFDM, Filter Bank Multicarrier (FBMC), Universal Filtered Multicarrier (UFMC), Generalized Frequency Division Multiplexing (GFDM), Wavelet Packet Modulation (WPM), Faster Than Nyquist (FTN) Waveform and low Peak to Average Power Ratio Waveform (low PAPR WF).

A frame structure component may specify a configuration of a frame or group of frames. The frame structure component may indicate one or more of a time, frequency, pilot signature, code or other parameter of the frame or group of frames. More details of frame structure will be discussed hereinafter.

A multiple access scheme component may specify multiple access technique options, including technologies defining how communicating devices share a common physical channel, such as: TDMA; FDMA; CDMA; SDMA; SC-FDMA; Low Density Signature Multicarrier CDMA (LDS-MC-CDMA); Non-Orthogonal Multiple Access (NOMA); Pattern Division Multiple Access (PDMA); Lattice Partition Multiple Access (LPMA); Resource Spread Multiple Access (RSMA); and Sparse Code Multiple Access (SCMA). Furthermore, multiple access technique options may include: scheduled access vs. non-scheduled access, also known as grant-free access; non-orthogonal multiple access vs. orthogonal multiple access, e.g., via a dedicated channel resource (e.g., no sharing between multiple communicating devices); contention-based shared channel resources vs. non-contention-based shared channel resources; and cognitive radio-based access.

A hybrid automatic repeat request (HARQ) protocol component may specify how a transmission and/or a re-transmission is to be made. Non-limiting examples of transmission and/or re-transmission mechanism options include those that specify a scheduled data pipe size, a signaling mechanism for transmission and/or re-transmission and a re-transmission mechanism.

A coding and modulation component may specify how information being transmitted may be encoded/decoded and modulated/demodulated for transmission/reception purposes. Coding may refer to methods of error detection and forward error correction. Non-limiting examples of coding options include turbo trellis codes, turbo product codes, fountain codes, low-density parity check codes and polar codes. Modulation may refer, simply, to the constellation (including, for example, the modulation technique and order), or more specifically to various types of advanced modulation methods such as hierarchical modulation and low PAPR modulation.

In some embodiments, the air interface may be a “one-size-fits-all” concept. For example, it may be that the components within the air interface cannot be changed or adapted once the air interface is defined. In some implementations, only limited parameters or modes of an air interface, such as a cyclic prefix (CP) length or a MIMO mode, can be configured. In some embodiments, an air interface design may provide a unified or flexible framework to support frequencies below known 6 GHz bands and frequencies beyond the 6 GHz bands (e.g., mmWave bands) for both licensed and unlicensed access. As an example, flexibility of a configurable air interface provided by a scalable numerology and symbol duration may allow for transmission parameter optimization for different spectrum bands and for different services/devices. As another example, a unified air interface may be self-contained in a frequency domain and a frequency domain self-contained design may support more flexible RAN slicing through channel resource sharing between different services in both frequency and time.

A frame structure is a feature of the wireless communication physical layer that defines a time domain signal transmission structure to, e.g., allow for timing reference and timing alignment of basic time domain transmission units. Wireless communication between communicating devices may occur on time-frequency resources governed by a frame structure. The frame structure may, sometimes, instead be called a radio frame structure.

Depending upon the frame structure and/or configuration of frames in the frame structure, frequency division duplex (FDD) and/or time-division duplex (TDD) and/or full duplex (FD) communication may be possible. FDD communication is when transmissions in different directions (e.g., uplink vs. downlink) occur in different frequency bands. TDD communication is when transmissions in different directions (e.g., uplink vs. downlink) occur over different time durations. FD communication is when transmission and reception occurs on the same time-frequency resource, i.e., a device can both transmit and receive on the same frequency resource contemporaneously.

One example of a frame structure is a frame structure, specified for use in the known long-term evolution (LTE) cellular systems, having the following specifications: each frame is 10 ms in duration; each frame has 10 subframes, which subframes are each 1 ms in duration; each subframe includes two slots, each of which slots is 0.5 ms in duration; each slot is for the transmission of seven OFDM symbols (assuming normal CP); each OFDM symbol has a symbol duration and a particular bandwidth (or partial bandwidth or bandwidth partition) related to the number of subcarriers and subcarrier spacing; the frame structure is based on OFDM waveform parameters such as subcarrier spacing and CP length (where the CP has a fixed length or limited length options); and the switching gap between uplink and downlink in TDD is specified as the integer time of OFDM symbol duration.

Another example of a frame structure is a frame structure, specified for use in the known new radio (NR) cellular systems, having the following specifications: multiple subcarrier spacings are supported, each subcarrier spacing corresponding to a respective numerology; the frame structure depends on the numerology but, in any case, the frame length is set at 10 ms and each frame consists of ten subframes, each subframe of 1 ms duration; a slot is defined as 14 OFDM symbols; and slot length depends upon the numerology. For example, the NR frame structure for normal CP 15 kHz subcarrier spacing (“numerology 1”) and the NR frame structure for normal CP 30 kHz subcarrier spacing (“numerology 2”) are different. For 15 kHz subcarrier spacing, the slot length is 1 ms and, for 30 kHz subcarrier spacing, the slot length is 0.5 ms. The NR frame structure may have more flexibility than the LTE frame structure.

Another example of a frame structure is, e.g., for use in a 6G network or a later network. In a flexible frame structure, a symbol block may be defined to have a duration that is the minimum duration of time that may be scheduled in the flexible frame structure. A symbol block may be a unit of transmission having an optional redundancy portion (e.g., CP portion) and an information (e.g., data) portion. An OFDM symbol is an example of a symbol block. A symbol block may alternatively be called a symbol. Embodiments of flexible frame structures include different parameters that may be configurable, e.g., frame length, subframe length, symbol block length, etc. A non-exhaustive list of possible configurable parameters, in some embodiments of a flexible frame structure, includes: frame length; subframe duration; slot configuration; subcarrier spacing (SCS); flexible transmission duration of basic transmission unit; and flexible switch gap.

The frame length need not be limited to 10 ms and the frame length may be configurable and change over time. In some embodiments, each frame includes one or multiple downlink synchronization channels and/or one or multiple downlink broadcast channels and each synchronization channel and/or broadcast channel may be transmitted in a different direction by different beamforming. The frame length may be more than one possible value and configured based on the application scenario. For example, autonomous vehicles may require relatively fast initial access, in which case the frame length may be set to 5 ms for autonomous vehicle applications. As another example, smart meters on houses may not require fast initial access, in which case the frame length may be set as 20 ms for smart meter applications.

A subframe might or might not be defined in the flexible frame structure, depending upon the implementation. For example, a frame may be defined to include slots, but no subframes. In frames in which a subframe is defined, e.g., for time domain alignment, the duration of the subframe may be configurable. For example, a subframe may be configured to have a length of 0.1 ms or 0.2 ms or 0.5 ms or 1 ms or 2 ms or 5 ms, etc. In some embodiments, if a subframe is not needed in a particular scenario, then the subframe length may be defined to be the same as the frame length or not defined.

A slot might or might not be defined in the flexible frame structure, depending upon the implementation. In frames in which a slot is defined, then the definition of a slot (e.g., in time duration and/or in number of symbol blocks) may be configurable. In one embodiment, the slot configuration is common to all UEs 110 or a group of UEs 110. For this case, the slot configuration information may be transmitted to the UEs 110 in a broadcast channel or common control channel(s). In other embodiments, the slot configuration may be UE specific, in which case the slot configuration information may be transmitted in a UE-specific control channel. In some embodiments, the slot configuration signaling can be transmitted together with frame configuration signaling and/or subframe configuration signaling. In other embodiments, the slot configuration may be transmitted independently from the frame configuration signaling and/or subframe configuration signaling. In general, the slot configuration may be system common, base station common, UE group common or UE specific.

The SCS may range from 15 KHz to 480 KHz. The SCS may vary with the frequency of the spectrum and/or maximum UE speed to minimize the impact of Doppler shift and phase noise. In some examples, there may be separate transmission and reception frames and the SCS of symbols in the reception frame structure may be configured independently from the SCS of symbols in the transmission frame structure. The SCS in a reception frame may be different from the SCS in a transmission frame. In some examples, the SCS of each transmission frame may be half the SCS of each reception frame. If the SCS between a reception frame and a transmission frame is different, the difference does not necessarily have to scale by a factor of two, e.g., if more flexible symbol durations are implemented using inverse discrete Fourier transform (IDFT) instead of fast Fourier transform (FFT). Additional examples of frame structures can be used with different SCSs.

The basic transmission unit may be a symbol block (alternatively called a symbol), which, in general, includes a redundancy portion (referred to as the CP) and an information (e.g., data) portion. In some embodiments, the CP may be omitted from the symbol block. The CP length may be flexible and configurable. The CP length may be fixed within a frame or flexible within a frame and the CP length may possibly change from one frame to another, or from one group of frames to another group of frames, or from one subframe to another subframe, or from one slot to another slot, or dynamically from one scheduling to another scheduling. The information (e.g., data) portion may be flexible and configurable. Another possible parameter relating to a symbol block that may be defined is ratio of CP duration to information (e.g., data) duration. In some embodiments, the symbol block length may be adjusted according to: a channel condition (e.g., multi-path delay, Doppler); and/or a latency requirement; and/or an available time duration. As another example, a symbol block length may be adjusted to fit an available time duration in the frame.

A frame may include both a downlink portion, for downlink transmissions from a base station 170, and an uplink portion, for uplink transmissions from the UEs 110. A gap may be present between each uplink and downlink portion, which gap is referred to as a switching gap. The switching gap length (duration) may be configurable. A switching gap duration may be fixed within a frame or flexible within a frame and a switching gap duration may possibly change from one frame to another, or from one group of frames to another group of frames, or from one subframe to another subframe, or from one slot to another slot, or dynamically from one scheduling to another scheduling.

A device, such as a base station 170, may provide coverage over a cell. Wireless communication with the device may occur over one or more carrier frequencies. A carrier frequency will be referred to as a carrier. A carrier may alternatively be called a component carrier (CC). A carrier may be characterized by its bandwidth and a reference frequency, e.g., the center frequency, the lowest frequency or the highest frequency of the carrier. A carrier may be on a licensed spectrum or an unlicensed spectrum. Wireless communication with the device may also, or instead, occur over one or more bandwidth parts (BWPs). For example, a carrier may have one or more BWPs. More generally, wireless communication with the device may occur over spectrum. The spectrum may comprise one or more carriers and/or one or more BWPs.

A cell may include one or multiple downlink resources and, optionally, one or multiple uplink resources. A cell may include one or multiple uplink resources and, optionally, one or multiple downlink resources. A cell may include both one or multiple downlink resources and one or multiple uplink resources. As an example, a cell might only include one downlink carrier/BWP, or only include one uplink carrier/BWP, or include multiple downlink carriers/BWPs, or include multiple uplink carriers/BWPs, or include one downlink carrier/BWP and one uplink carrier/BWP, or include one downlink carrier/BWP and multiple uplink carriers/BWPs, or include multiple downlink carriers/BWPs and one uplink carrier/BWP, or include multiple downlink carriers/BWPs and multiple uplink carriers/BWPs. In some embodiments, a cell may, instead or additionally, include one or multiple sidelink resources, including sidelink transmitting and receiving resources.

A BWP is a set of contiguous or non-contiguous frequency subcarriers on a carrier, or a set of contiguous or non-contiguous frequency subcarriers on multiple carriers, or a set of non-contiguous or contiguous frequency subcarriers, which may have one or more carriers.

In some embodiments, a carrier may have one or more BWPs, e.g., a carrier may have a bandwidth of 20 MHz and consist of one BWP or a carrier may have a bandwidth of 80 MHz and consist of two adjacent contiguous BWPs, etc. In other embodiments, a BWP may have one or more carriers, e.g., a BWP may have a bandwidth of 40 MHz and consist of two adjacent contiguous carriers, where each carrier has a bandwidth of 20 MHz. In some embodiments, a BWP may comprise non-contiguous spectrum resources, which consists of multiple non-contiguous multiple carriers, where the first carrier of the non-contiguous multiple carriers may be in the mmW band, the second carrier may be in a low band (such as the 2 GHz band), the third carrier (if it exists) may be in THz band and the fourth carrier (if it exists) may be in visible light band. Resources in one carrier which belong to the BWP may be contiguous or non-contiguous. In some embodiments, a BWP has non-contiguous spectrum resources on one carrier.

Wireless communication may occur over an occupied bandwidth. The occupied bandwidth may be defined as the width of a frequency band such that, below the lower and above the upper frequency limits, the mean powers emitted are each equal to a specified percentage, β/2, of the total mean transmitted power, for example, the value of β/2 is taken as 0.5%.

The carrier, the BWP or the occupied bandwidth may be signaled by a network device (e.g., by a base station 170) dynamically, e.g., in physical layer control signaling such as the known downlink control channel (DCI), or semi-statically, e.g., in radio resource control (RRC) signaling or in signaling in the medium access control (MAC) layer, or be predefined based on the application scenario; or be determined by the UE 110 as a function of other parameters that are known by the UE 110, or may be fixed, e.g., by a standard.

User Equipment (UE) position information is often used in cellular communication networks to improve various performance metrics for the network. Such performance metrics may, for example, include capacity, agility and efficiency. The improvement may be achieved when elements of the network exploit the position, the behavior, the mobility pattern, etc., of the UE in the context of a priori information describing a wireless environment in which the UE is operating.

A sensing system may be used to help gather UE pose information, including UE location in a global coordinate system, UE velocity and direction of movement in the global coordinate system, orientation information and the information about the wireless environment. “Location” is also known as “position” and these two terms may be used interchangeably herein. Examples of well-known sensing systems include RADAR (Radio Detection and Ranging) and LIDAR (Light Detection and Ranging). While the sensing system can be separate from the communication system, it could be advantageous to gather the information using an integrated system, which reduces the hardware (and cost) in the system as well as the time, frequency or spatial resources needed to perform both functionalities. However, using the communication system hardware to perform sensing of UE pose and environment information is a highly challenging and open problem. The difficulty of the problem relates to factors such as the limited resolution of the communication system, the dynamicity of the environment, and the huge number of objects whose electromagnetic properties and position are to be estimated.

Accordingly, integrated sensing and communication (also known as integrated communication and sensing) is a desirable feature in existing and future communication systems.

Any or all of the EDs 110 and BS 170 may be sensing nodes in the system 100. Sensing nodes are network entities that perform sensing by transmitting and receiving sensing signals. Some sensing nodes are communication equipment that perform both communications and sensing. However, it is possible that some sensing nodes do not perform communications and are, instead, dedicated to sensing. The sensing agent 174 is an example of a sensing node that is dedicated to sensing. Unlike the EDs 110 and BS 170, the sensing agent 174 does not transmit or receive communication signals. However, the sensing agent 174 may communicate configuration information, sensing information, signaling information, or other information within the communication system 100. The sensing agent 174 may be in communication with the core network 130 to communicate information with the rest of the communication system 100. By way of example, the sensing agent 174 may determine the location of the ED 110a, and transmit this information to the base station 170a via the core network 130. Although only one sensing agent 174 is shown in FIG. 2, any number of sensing agents may be implemented in the communication system 100. In some embodiments, one or more sensing agents may be implemented at one or more of the RANs 120.

A sensing node may combine sensing-based techniques with reference signal-based techniques to enhance UE pose determination. This type of sensing node may also be known as a sensing management function (SMF). In some networks, the SMF may also be known as a location management function (LMF). The SMF may be implemented as a physically independent entity located at the core network 130 with connection to the multiple BSs 170. In other aspects of the present application, the SMF may be implemented as a logical entity co-located inside a BS 170 through logic carried out by the processor 260.

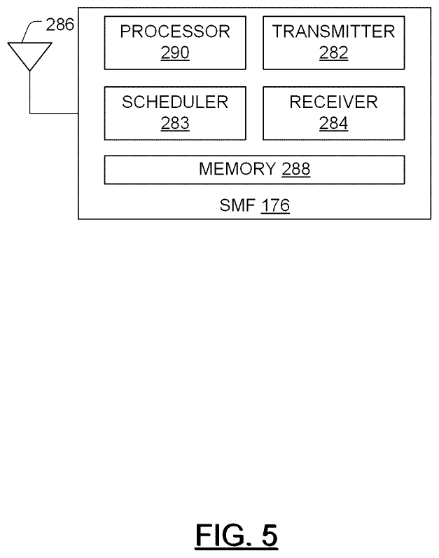

As shown in FIG. 5, an SMF 176, when implemented as a physically independent entity, includes at least one processor 290, at least one transmitter 282, at least one receiver 284, one or more antennas 286 and at least one memory 288. A transceiver, not shown, may be used instead of the transmitter 282 and the receiver 284. A scheduler 283 may be coupled to the processor 290. The scheduler 283 may be included within or operated separately from the SMF 176. The processor 290 implements various processing operations of the SMF 176, such as signal coding, data processing, power control, input/output processing or any other functionality. The processor 290 can also be configured to implement some or all of the functionality and/or embodiments described in more detail above. Each processor 290 includes any suitable processing or computing device configured to perform one or more operations. Each processor 290 could, for example, include a microprocessor, microcontroller, digital signal processor, field programmable gate array or application specific integrated circuit.

A reference signal-based pose determination technique belongs to an “active” pose estimation paradigm. In an active pose estimation paradigm, the enquirer of pose information (e.g., the UE 110) takes part in process of determining the pose of the enquirer. The enquirer may transmit or receive (or both) a signal specific to pose determination process. Positioning techniques based on a global navigation satellite system (GNSS) such as the known Global Positioning System (GPS) are other examples of the active pose estimation paradigm.

In contrast, a sensing technique, based on radar for example, may be considered as belonging to a “passive” pose determination paradigm. In a passive pose determination paradigm, the target is oblivious to the pose determination process.

By integrating sensing and communications in one system, the system need not operate according to only a single paradigm. Thus, the combination of sensing-based techniques and reference signal-based techniques can yield enhanced pose determination.

The enhanced pose determination may, for example, include obtaining UE channel sub-space information, which is particularly useful for UE channel reconstruction at the sensing node, especially for a beam-based operation and communication. The UE channel sub-space is a subset of the entire algebraic space, defined over the spatial domain, in which the entire channel from the TP to the UE lies. Accordingly, the UE channel sub-space defines the TP-to-UE channel with very high accuracy. The signals transmitted over other sub-spaces result in a negligible contribution to the UE channel. Knowledge of the UE channel sub-space helps to reduce the effort needed for channel measurement at the UE and channel reconstruction at the network-side. Therefore, the combination of sensing-based techniques and reference signal-based techniques may enable the UE channel reconstruction with much less overhead as compared to traditional methods. Sub-space information can also facilitate sub-space-based sensing to reduce sensing complexity and improve sensing accuracy.

In some embodiments of integrated sensing and communication, a same radio access technology (RAT) is used for sensing and communication. This avoids the need to multiplex two different RATs under one carrier spectrum, or necessitating two different carrier spectrums for the two different RATs.

In embodiments that integrate sensing and communication under one RAT, a first set of channels may be used to transmit a sensing signal and a second set of channels may be used to transmit a communications signal. In some embodiments, each channel in the first set of channels and each channel in the second set of channels is a logical channel, a transport channel or a physical channel.

At the physical layer, communication and sensing may be performed via separate physical channels. For example, a first physical downlink shared channel PDSCH-C is defined for data communication, while a second physical downlink shared channel PDSCH-S is defined for sensing. Similarly, separate physical uplink shared channels (PUSCH), PUSCH-C and PUSCH-S, could be defined for uplink communication and sensing.

In another example, the same PDSCH and PUSCH could be also used for both communication and sensing, with separate logical layer channels and/or transport layer channels defined for communication and sensing. Note also that control channel(s) and data channel(s) for sensing can have the same or different channel structure (format), occupy same or different frequency bands or bandwidth parts.

In a further example, a common physical downlink control channel (PDCCH) and a common physical uplink control channel (PUCCH) may be used to carry control information for both sensing and communication. Alternatively, separate physical layer control channels may be used to carry separate control information for communication and sensing. For example, PUCCH-S and PUCCH-C could be used for uplink control for sensing and communication respectively and PDCCH-S and PDCCH-C for downlink control for sensing and communication respectively.

Different combinations of shared and dedicated channels for sensing and communication, at each of the physical, transport, and logical layers, are possible.

The term RADAR originates from the phrase Radio Detection and Ranging; however, expressions with different forms of capitalization (e.g., Radar and radar) are equally valid and now more common. Radar is typically used for detecting a presence and a location of an object. A radar system radiates radio frequency energy and receives echoes of the energy reflected from one or more targets. The system determines the pose of a given target based on the echoes returned from the given target. The radiated energy can be in the form of an energy pulse or a continuous wave, which can be expressed or defined by a particular waveform. Examples of waveforms used in radar include frequency modulated continuous wave (FMCW) and ultra-wideband (UWB) waveforms.

Radar systems can be monostatic, bi-static or multi-static. In a monostatic radar system, the radar signal transmitter and receiver are co-located, such as being integrated in a transceiver. In a bi-static radar system, the transmitter and receiver are spatially separated, and the distance of separation is comparable to, or larger than, the expected target distance (often referred to as the range). In a multi-static radar system, two or more radar components are spatially diverse but with a shared area of coverage. A multi-static radar is also referred to as a multisite or netted radar.

Terrestrial radar applications encounter challenges such as multipath propagation and shadowing impairments. Another challenge is the problem of identifiability because terrestrial targets have similar physical attributes. Integrating sensing into a communication system is likely to suffer from these same challenges, and more.

Communication nodes can be either half-duplex or full-duplex. A half-duplex node cannot both transmit and receive using the same physical resources (time, frequency, etc.); conversely, a full-duplex node can transmit and receive using the same physical resources. Existing commercial wireless communications networks are all half-duplex. Even if full-duplex communications networks become practical in the future, it is expected that at least some of the nodes in the network will still be half-duplex nodes because half-duplex devices are less complex, and have lower cost and lower power consumption. In particular, full-duplex implementation is more challenging at higher frequencies (e.g., in millimeter wave bands) and very challenging for small and low-cost devices, such as femtocell base stations and UEs.

The limitation of half-duplex nodes in the communications network presents further challenges toward integrating sensing and communications into the devices and systems of the communications network. For example, both half-duplex and full-duplex nodes can perform bi-static or multi-static sensing, but monostatic sensing typically requires the sensing node have full-duplex capability. A half-duplex node may perform monostatic sensing with certain limitations, such as in a pulsed radar with a specific duty cycle and ranging capability.

Properties of a sensing signal, or a signal used for both sensing and communication, include the waveform of the signal and the frame structure of the signal. The frame structure defines the time-domain boundaries of the signal. The waveform describes the shape of the signal as a function of time and frequency. Examples of waveforms that can be used for a sensing signal include ultra-wide band (UWB) pulse, Frequency-Modulated Continuous Wave (FMCW) or “chirp”, orthogonal frequency-division multiplexing (OFDM), cyclic prefix (CP)-OFDM, and Discrete Fourier Transform spread (DFT-s)-OFDM.

In an embodiment, the sensing signal is a linear chirp signal with bandwidth B and time duration T. Such a linear chirp signal is generally known from its use in FMCW radar systems. A linear chirp signal is defined by an increase in frequency from an initial frequency, ƒ_{chirp0}, at an initial time, t_{chirp0}, to a final frequency, ƒ_{chirp1}, at a final time, t_{chirp1} where the relation between the frequency (ƒ) and time (t) can be expressed as a linear relation of ƒ−ƒ_{chirp0}=α(t−t_{chirp0}), where

$$α = \frac{{f}_{chirp 1} - {f}_{chirp 0}}{{t}_{chirp 1} - {t}_{chirp 0}}$$

is defined as the chirp slope. The bandwidth of the linear chirp signal may be defined as B=ƒ_{chirp1}−ƒ_{chirp0} and the time duration of the linear chirp signal may be defined as T=t_{chirp1}−t_{chirp0}. Such linear chirp signal can be presented as e^{jπαt}^{²} in the baseband representation.

Precoding, as used herein, may refer to any coding operation(s) or modulation(s) that transform an input signal into an output signal. Precoding may be performed in different domains and typically transforms the input signal in a first domain to an output signal in a second domain. Precoding may include linear operations.

A terrestrial communication system may also be referred to as a land-based or ground-based communication system, although a terrestrial communication system can also, or instead, be implemented on or in water. The non-terrestrial communication system may bridge coverage gaps in underserved areas by extending the coverage of cellular networks through the use of non-terrestrial nodes, which will be key to establishing global, seamless coverage and providing mobile broadband services to unserved/underserved regions. In the current case, it is hardly possible to implement terrestrial access-points/base-stations infrastructure in areas like oceans, mountains, forests, or other remote areas.

The terrestrial communication system may be a wireless communications system using 5G technology and/or later generation wireless technology (e.g., 6G or later). In some examples, the terrestrial communication system may also accommodate some legacy wireless technologies (e.g., 3G or 4G wireless technology). The non-terrestrial communication system may be a communications system using satellite constellations, like conventional Geo-Stationary Orbit (GEO) satellites, which utilize broadcast public/popular contents to a local server. The non-terrestrial communication system may be a communications system using low earth orbit (LEO) satellites, which are known to establish a better balance between large coverage area and propagation path-loss/delay. The non-terrestrial communication system may be a communications system using stabilized satellites in very low earth orbits (VLEO) technologies, thereby substantially reducing the costs for launching satellites to lower orbits. The non-terrestrial communication system may be a communications system using high altitude platforms (HAPs), which are known to provide a low path-loss air interface for the users with limited power budget. The non-terrestrial communication system may be a communications system using Unmanned Aerial Vehicles (UAVs) (or unmanned aerial system, “UAS”) achieving a dense deployment, since their coverage can be limited to a local area, such as airborne, balloon, quadcopter, drones, etc. In some examples, GEO satellites, LEO satellites, UAVs, HAPs and VLEOs may be horizontal and two-dimensional. In some examples, UAVs, HAPs and VLEOs may be coupled to integrate satellite communications to cellular networks. Emerging 3D vertical networks consist of many moving (other than geostationary satellites) and high altitude access points such as UAVs, HAPs and VLEOs.

MIMO technology allows an antenna array of multiple antennas to perform signal transmissions and receptions to meet high transmission rate requirements. The ED 110 and the T-TRP 170 and/or the NT-TRP may use MIMO to communicate using wireless resource blocks. MIMO utilizes multiple antennas at the transmitter to transmit wireless resource blocks over parallel wireless signals. It follows that multiple antennas may be utilized at the receiver. MIMO may beamform parallel wireless signals for reliable multipath transmission of a wireless resource block. MIMO may bond parallel wireless signals that transport different data to increase the data rate of the wireless resource block.

In recent years, a MIMO (large-scale MIMO) wireless communication system with the T-TRP 170 and/or the NT-TRP 172 configured with a large number of antennas has gained wide attention from academia and industry. In the large-scale MIMO system, the T-TRP 170, and/or the NT-TRP 172, is generally configured with more than ten antenna units (see antennas 256 and antennas 280 in FIG. 3). The T-TRP 170, and/or the NT-TRP 172, is generally operable to serve dozens (such as 40) of EDs 110. A large number of antenna units of the T-TRP 170 and the NT-TRP 172 can greatly increase the degree of spatial freedom of wireless communication, greatly improve the transmission rate, spectrum efficiency and power efficiency, and, to a large extent, reduce interference between cells. The increase of the number of antennas allows for each antenna unit to be made in a smaller size with a lower cost. Using the degree of spatial freedom provided by the large-scale antenna units, the T-TRP 170 and the NT-TRP 172 of each cell can communicate with many EDs 110 in the cell on the same time-frequency resource at the same time, thus greatly increasing the spectrum efficiency. A large number of antenna units of the T-TRP 170 and/or the NT-TRP 172 also enable each user to have better spatial directivity for uplink and downlink transmission, so that the transmitting power of the T-TRP 170 and/or the NT-TRP 172 and an ED 110 is reduced and the power efficiency is correspondingly increased. When the antenna number of the T-TRP 170 and/or the NT-TRP 172 is sufficiently large, random channels between each ED 110 and the T-TRP 170 and/or the NT-TRP 172 can approach orthogonality such that interference between cells and users and the effect of noise can be reduced. The plurality of advantages described hereinbefore enable large-scale MIMO to have a magnificent application prospect.

A MIMO system may include a receiver connected to a receive (Rx) antenna, a transmitter connected to transmit (Tx) antenna and a signal processor connected to the transmitter and the receiver. Each of the Rx antenna and the Tx antenna may include a plurality of antennas. For instance, the Rx antenna may have a uniform linear array (ULA) antenna, in which the plurality of antennas are arranged in line at even intervals. When a radio frequency (RF) signal is transmitted through the Tx antenna, the Rx antenna may receive a signal reflected and returned from a forward target.

A non-exhaustive list of possible unit or possible configurable parameters or in some embodiments of a MIMO system include: a panel; and a beam.

A panel is a unit of an antenna group, or antenna array, or antenna sub-array, which unit can control a Tx beam or a Rx beam independently.

A beam may be formed by performing amplitude and/or phase weighting on data transmitted or received by at least one antenna port. A beam may be formed by using another method, for example, adjusting a related parameter of an antenna unit. The beam may include a Tx beam and/or an Rx beam. The transmit beam indicates distribution of signal strength formed in different directions in space after a signal is transmitted through an antenna. The receive beam indicates distribution of signal strength that is of a wireless signal received from an antenna and that is in different directions in space. Beam information may include a beam identifier, or an antenna port(s) identifier, or a channel state information reference signal (CSI-RS) resource identifier, or a SSB resource identifier, or a sounding reference signal (SRS) resource identifier, or other reference signal resource identifier.

Depending on an underlying antenna array structure and a radiation pattern of each individual antenna element, a total beamforming gain and/or a beam width of a main lobe may be shown to change responsive to a shift, from one direction to another, in a steered beam of an antenna array. For example, a transmission gain for a dipole antenna and, hence, the total beamforming gain of the array of such antennas, may be shown to tend to zero as an elevation angle associated with a main lobe approaches ±90°.

On the other hand, when considering an array of antennas, such as a linear phased array, the beam-width of the main lobe may be shown to increase responsive to the beam being shifted from a broadside of the array to an end-fire direction. This, in turn, implies that spatial filtering capabilities of a certain node may vary in different directions.

In general, nodes (UEs 110 and TRPs 170/172) in a network can effectively communicate with each other when a beam alignment direction between the nodes exists in a certain angular range. This certain angular range may be shown to depend on an underlying antenna array structure or an underlying panels structure. It may, further, be shown that, when beam alignment directions approach extreme limits of this certain angular range, the beamforming gain/directionality cannot be improved beyond a certain limit without adjusting the relative position of the transmitter and/or receiver.

A desired angular range for a receive beam direction (part of the beam alignment direction) may be further restricted by a UE 110 based on the UE 110 sensing the surrounding environment and obtaining other local measurements. For example, the UE 110 can exclude directions where a barrier is sensed at a certain distance, so that the UE 110 may maximize a chance to have a line-of-sight (LoS) connection to a TRP 170/172. In the same way, the UE 110 can exclude the directions where a human body or skull is detected at a nearby distance, thereby limiting exposure of electromagnetic energy to the human body or skull. The UE 110 can also exclude the directions in which interference has been observed to exceed a certain threshold.

In the current state of the art, the relative position of the transmitter and receiver and, thus, the direction of the transmitted beam, can be updated only by switching the TRP 170/172. Such TRP switching is typically carried out responsive to the UE 110 experiencing a so-called beam failure.

In overview, aspects of the present application relate to preventing a beam failure by adaptively updating the position of NT-TRPs 172. Further aspects of the present application relate to a case wherein the beam direction cannot be maintained in a desired range and, responsively, a TRP switching is triggered in advance of a potential occurrence of a beam failure.

Conveniently, aspects of the present application may be shown to boost achievable beamforming gain. Additionally, aspects of the present application may be shown to reduce imposed interference for the UE 110, while enhancing a spatial multiplexing gain in the network.

Aspects of the present application may be shown to rely upon assuming that beamforming and beam tracking are implemented, so that transmitter beams and receiver beams are aligned at each position.

Aspects of the present application relate to changing a beam alignment direction between the transmitter and the receiver, within a desired range, by adaptively adjusting the position of the transmitter relative to the receiver. Indeed, the flexibility to adjust the position of NT-TRPs 172 introduces new degrees of freedom. These new degrees of freedom may be shown to be exploitable to optimize the beam alignment direction based on indications received from the UE 110.

Aspects of the present application relate to exploiting the flexibility of adjusting the location of the NT-TRP 172 relative to the UE 110. The location adjustment may be used to avoid a situation wherein a beam, over which the NT-TRP 172 and the UE 110 are communicating, extends into an uncovered or undesirable region. The location adjustment may be used to enhance beamforming and directionality. The location adjustment may also be used to maximize spatial multiplexing gain. The position adjustment may further be used to mitigate co-channel interference in a network, such as the network 100 illustrated in FIG. 2, including both T-TRPs 170 and NT-TRPs 172.

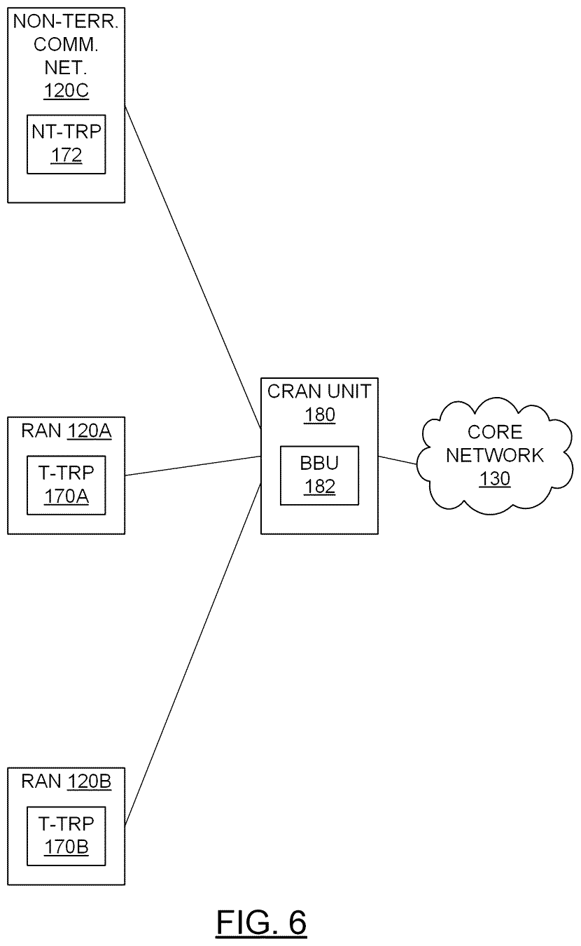

FIG. 6 illustrates elements of FIG. 2 with some additional elements. The elements that are familiar from FIG. 2 include the core network 130, the RAN 120A (including the T-TRP 170a), the RAN 120B (including the T-TRP 170) and the non-terrestrial communication network 120C (including the NT-TRP 172). New in FIG. 6 is a central radio access network (“CRAN”) unit 180, which includes a base band unit (“BBU”) 182. The CRAN unit 180 interposes, and connects to, the core network 130, the RAN 120A, the RAN 120B and the non-terrestrial communication network 120C.

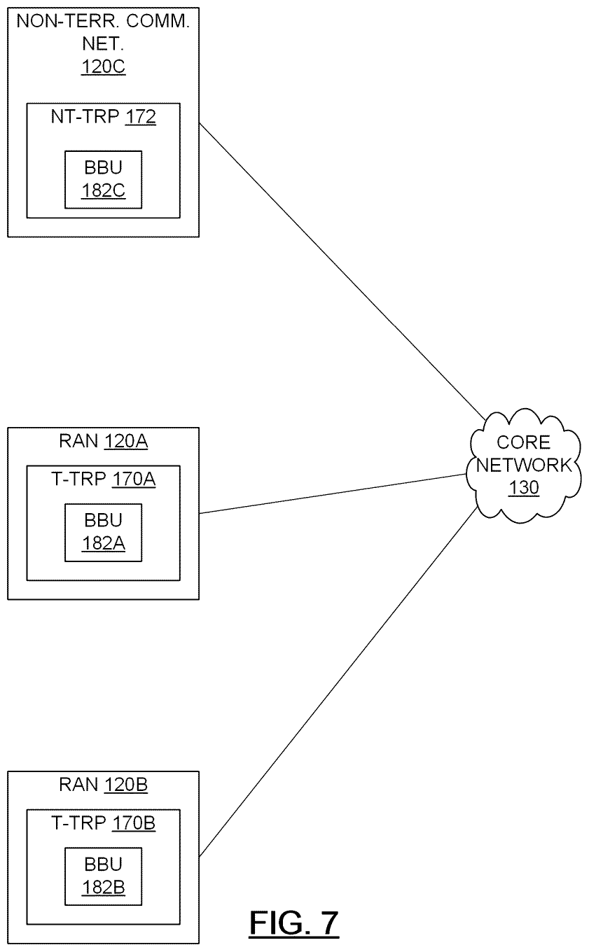

FIG. 7 illustrates elements of FIG. 2 with some additional elements. The elements that are familiar from FIG. 2 include the core network 130, the RAN 120A (including the T-TRP 170a), the RAN 120B (including the T-TRP 170) and the non-terrestrial communication network 120C (including the NT-TRP 172). New in FIG. 6 is a BBU 182A in the T-TRP 170A, a BBU 182B in the T-TRP 170B and a BBU 182C in the NT-TRP 172.

In overview, in aspects of the present application, feedback from a UE 110 may be used by a BBU 182 to provide an NT-TRP 172 with location-specific adjustments.

The feedback from the UE 110 can be indicative of a direction that the UE 110 cannot transmit/receive a signal (e.g., because of a nearby barrier or other restrictions such as the maximum permissible exposure). The feedback from the UE 110 can be indicative of a restriction imposed by UE-related features/capabilities (such as the required angular range for the receive beam direction at the UE 110, the minimum angular separation between the receive beam directions, and the like). The feedback from the UE 110 can be indicative of any other restrictions that may be imposed by making measurements and sensing the surrounding environment (such as a direction that a strong source of interference is observed).

Aspects of the present application relate to signaling that can be used to adaptively adjust a location of an NT-TRP 172 so as to optimize a direction associated with a beam connecting an UE 110 to the NT-TRP 172. Adaptive adjustment of the location of the NT-TRP 172 may allow for avoidance of situations wherein the beam terminates in an uncovered region. Based on feedback from UEs 110, the NT-TRPs 172 may be configured, by the BBU 182, with specific values. Such values may, for example, include minimum and maximum elevation angles with respect to a certain reference point. Such values may, for another example, include minimum and maximum azimuth angles with respect to a certain reference point. Where the NT-TRP 172 complies with the configured values, interference among the NT-TRPs 172 and the T-TRPs 170 may be mitigated. Aspects of the present application relate to signaling that can be useful for on-demand deployment of NT-TRPs 172 and adaptively adjusting the location of the deployed NT-TRPs 172 so as to enhance a spatial multiplexing gain.

Aspects of the present application relate to adaptively updating the location of the NT-TRP 172, based on feedback received from UEs 110, so as to maintain beam alignment direction within a desired range. Particularly, in view of the restrictions of the underlying antenna array structure or based on local measurements and sensing, the UE 110 may determine a desired angular range in which the UE 110 can effectively maintain a connection. The desired angular range may be determined, for one example, as a range of directions wherein achievable beamforming gain (of the main lobe) is greater than a certain threshold. The desired angular range can be determined, for a second example, as a range of directions wherein the beam width (of the main lobe) is smaller than a certain threshold. The desired angular range can be determined, for a third example, as a range of directions wherein the observed interference level is smaller than a certain threshold. The UE 110 can further restrict the desired angular range responsive to detecting a barrier over a certain angular range, thereby maximizing the chance to have a LOS connection with the NT-TRP 172. The UE 110 can further exclude directions wherein a human body or skull has been detected at a nearby distance, thereby limiting exposure of electromagnetic energy to the human body or skull. The UE 110, upon determining the desired angular range and upon determining that the UE 110 is approaching the limits of the desired angular range, may transmit, to the NT-TRP 172, feedback indicating a desired change to the beam alignment direction.

The desired change to the beam alignment direction may be adopted, by the NT-TRP 172, to avoid a situation wherein the beam alignment direction is such that achievable beamforming gain or directionality is insufficient. The desired change to the beam alignment direction may be adopted, by the NT-TRP 172, to help to spatially filter a strong interference signal. The desired change to the beam alignment direction may be adopted, by the NT-TRP 172, to optimize the beam alignment direction, thereby boosting the achievable beamforming gain or directionality.

The feedback transmitted, to the NT-TRP 172 by the UE 110, may indicate an angular distance to a nearby barrier as the UE 110 approaches the barrier.

The feedback transmitted, to the NT-TRP 172 by the UE 110, may indicate a maximum angular range over which a connection can be maintained.

It is worth noting that the NT-TRP 172 may implement a change to the beam alignment direction only after adjusting the relative position of the NT-TRP 172 and the UE 110. Indeed, assuming a perfectly aligned pair of transmitter-receiver beams, rotating the beam (without adjusting the location of each of the transmitter/receiver) simply takes the beam out of alignment. It follows that feedback related to changing the beam alignment direction in conjunction with NT-TRP 172 location adjustment should be distinguished from signaling that is indicative of rotating the beams to track the beam alignment direction without NT-TRP 172 location adjustment.

A desired change to the beam alignment direction, indicated in feedback received from a particular UE 110, may be translated, by the NT-TRP 172, into a specific adjustment in the location of the NT-TRP 172. Given feedback received from different UEs 110, the BBU 182 may decide upon the adjustment to the location of the NT-TRP 172. The actual change to the beam alignment direction, resulting from the adjustment to the location of the NT-TRP 172, may be signaled to the UEs 110 to allow for beam alignment direction adjustment on the UE 110 end. Aspects of the present application relate to indicating, to a particular UE 110, a switch from a first NT-TRP 172 to a second NT-TRP 172. The indication of the switch may be responsive to establishing that the beam alignment direction for the particular UE 110 cannot be maintained in the range indicated as desired by the particular UE 110 by adjusting the location of the first NT-TRP 172.

For instance, consider an i^{th} ground UE 110 being served by an NT-TRP 172 at a range, Rᵢ, at an elevation angle, θᵢ. An altitude, hᵢ, for the NT-TRP 172 may be shown to be related to the range and elevation angle through an expression, hᵢ=Rᵢ sin θᵢ. As discussed hereinbefore, a UE 110 may indicate, in feedback, a desired change to the beam alignment direction. The NT-TRP 172 may translate the desired change into a specific adjustment in the location of the NT-TRP 172. Sometimes, the specific adjustment in the location of the NT-TRP 172 is limited to only an adjustment in the altitude of the NT-TRP 172. This altitude adjustment may be represented as Δhᵢ. Other times, adjustments in the location of the NT-TRP 172 may be in a two-dimensional plane that is orthogonal to a vector representative of the altitude of the NT-TRP 172. That is, adjustments in the location of the NT-TRP 172 may be adjustments of two-dimensional coordinates. Still other times, adjustments in the location of the NT-TRP 172 may include an adjustment in the altitude of the NT-TRP 172 and adjustments of two-dimensional coordinates.

Where the i^{th} ground-based UE 110 has indicated, in feedback, a desired change to the beam alignment direction in terms of a small change, Δθᵢ, in the elevation angle, the altitude adjustment, Δhᵢ, that implements the change to the elevation angle, may be translated using Δhᵢ≅Rᵢ cos θᵢΔθᵢ. When multiple UEs 110 indicate a desired change to their respective beam alignment directions, the location (altitude, in this case) of the NT-TRP 172 can be self-adjusted based on a weighted sum of individual altitude adjustments corresponding to the desired changes for the different UEs 110. The NT-TRP 172 may first determine, from the individual desired changes, individual altitude adjustments, Δhᵢ. The NT-TRP 172 may then determine the weighted sum of individual altitude adjustments as Δh:=ΣᵢαᵢΔhᵢ, where αᵢ is a UE-specific weight. Each UE-specific weight, αᵢ, may be tuned, by the NT-TRP 172, based on a perceived urgency to adjust the beam alignment direction for the corresponding UE 110. Upon determining the weighted sum, the NT-TRP 172 may

Over the course of multiple time intervals, the NT-TRP 172 may repeatedly determine and implement an adjustment to its location (either an adjustment in altitude or adjustments of two-dimensional coordinates, or both) until the beam alignment direction associated with each UE 110 is within a desired range associated with each UE 110. If the beam alignment direction for a particular UE 110 is not improved after a predetermined number of time intervals, the particular UE 110 may be proactively switched to another NT-TRP 172 before the beam alignment direction reaches an uncovered region.

The plurality of NT-TRPs 172 may, as illustrated in FIGS. 2, 6 and 7, operate in the presence of a plurality of T-TRPs 170. The plurality of NT-TRPs 172 may be considered to be a non-terrestrial “tier” of operation. Similarly, the plurality of T-TRPs 170 may be considered to be a terrestrial tier of operation. Interference is known to arise between signals transmitted and received in the non-terrestrial tier of operation and signals transmitted and received in the terrestrial tier of operation. This interference may be called cross-tier interference.

In aspects of the present application, the BBU 182 provides each NT-TRP 172, among a plurality of NT-TRPs 172, with a location-specific configuration. Each location-specific configuration may be designed to mitigate the cross-tier interference between the NT-TRPs 172 and the T-TRPs 170. Particularly, the transmission by a NT-TRP 172 in the downlink direction may interfere, at the UE 110, with a transmissions by one or more T-TRPs 170 in the downlink direction. Similarly, the transmission by a UE 110 in the uplink direction towards an NT-TRP 172 may interfere, at a T-TRP 170, with uplink transmission of other UEs 110. It follows that the transmission, by a UE 110 in the uplink direction towards a T-TRP 170 may interfere, at an NT-TRP 172 with uplink transmissions of other UEs 110.

Each location-specific configuration may further be designed to manage co-channel interference, as discussed in the following.

It may be understood that a generic aerial node may serve as an NT-TRP 172 or as an UE 110. For the scenario in which a UE 110 is an aerial node, a transmission in an uplink direction from the aerial UE 110 to an NT-TRP 172 (or to a T-TRP 170) may be shown to interfere with downlink transmission from T-TRPs 170 (or NT-TRPs 172) to ground-based UEs 110 (and vice versa), when they share common resources in the uplink direction and the downlink direction.

This scenario may be shown to occur when asymmetric loads in the downlink direction and the uplink direction are accommodated. This accommodation may be implemented, especially for aerial UEs 110, using flexible duplexing or other technologies, such as in-band full-duplexing.

An uplink transmission from a terrestrial UE 110 and an uplink transmission from an aerial UE 110 may be shown to interfere with each other in the presence of a bi-directional antenna at a T-TRP 170.

Aspects of the present application relate to mitigating, at a terrestrial UE 110, interference from aerial UEs 110 or from NT-TRPs 172. Indeed, the BBU 182 may configure the aerial UEs 110 (or the NT-TRPs 172) to maintain beam alignment direction with an elevation angle that does not exceed a maximum elevation angle with respect to a certain reference point, such as a serving TRP 170/172. Such a configuration may be shown to allow terrestrial UEs 110 to spatially filter interference signals that are transmitted from aerial UEs 110 or from NT-TRPs 172. Similarly, such a configuration may be shown to allow aerial UEs 110 to spatially filter interference signals that are transmitted from T-TRPs 170.

To properly configure the maximum elevation angle, the BBU 182 benefits from information related to an angular separation that is required at the UEs 110 so that the UEs 110 can spatially filter distinct incoming signals. To select minimum and maximum elevation angles for the aerial UEs 110, the BBU 182 may also take into account restrictions associated with a radiation pattern in place at the T-TRPs 170.

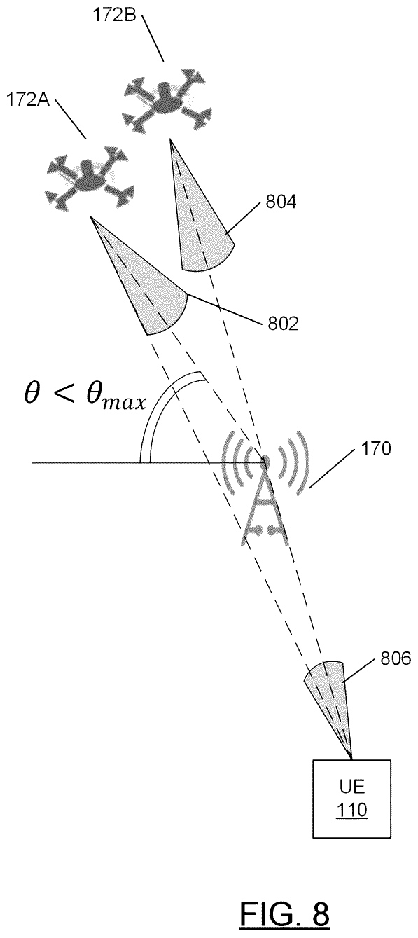

FIG. 8 illustrates a scenario including a first NT-TRP 172A, a second NT-TRP 172B, a T-TRP 170 and a UE 110. The first NT-TRP 172A and the second NT-TRP 172B may be generally referenced as “aerial nodes.” The UE 110 is associated with a desired angular separation 806. In view of a condition wherein the UE 110 has an ongoing connection to the first NT-TRP 172A, the desired angular separation 806 may be understood to establish that a further connection may not be established with either the second NT-TRP 172B or the T-TRP 170. Moreover, in case that the aerial nodes 172A, 172B serve an aerial UE 110, the desired angular separation 806 at the UE 110 implies that the aerial nodes 172A, 172B cannot share common resources unless the aerial nodes 172A, 172B respect a maximum elevation angle.

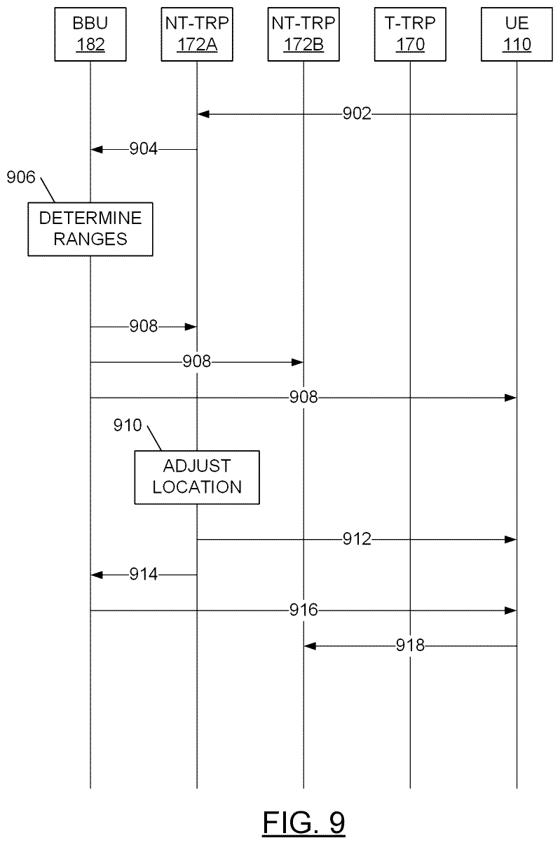

FIG. 9 illustrates a signal flow among the elements of FIG. 8. Notably, the BBU 182 is not illustrated in FIG. 8 but is understood to be present and controlling the elements of FIG. 8.

According to aspects of the present application, the UE 110 signals (902), to the serving TRP (the first NT-TRP 172A), an indication of information that is specific to the UE 110. The information may take many forms, including a desired angular separation 806. Indeed, the information that is specific to the UE 110 may include features that are specific to the UE 110, such as an antenna array structure. The information may also take the form of an indication of a measurement made at the UE 110.

The desired angular separation 806 may be defined as the angular separation that allows the UE 110 to decode a transmitted signal from the serving TRP 170/172 in the presence of a transmitted signal from another TRP 170/172. The desired angular separation 806 may be understood to be related to capabilities that are specific to the UE 110. Such capabilities may be shown to depend, mainly, on a beam-width of a main-lobe of the antenna 204 used by the UE 110. Notably, the considerations discussed in view of FIG. 8 apply equally to ground-based UEs 110 or aerial UEs 110.

The first NT-TRP 172A signals (904) the desired angular separation 806 to the BBU 182. The first NT-TRP 172A may also signal (904), to the BBU 182, other UE-related information, such as a desired receive beam direction.

Based on the received signaling (904) and by using the knowledge of deployment of the T-TRP 170, the BBU 182 may determine (step 906) a range (minimum and maximum) of elevation angles to be maintained by the NT-TRPs 172A, 172B. In general, the BBU 182 may also establish a range (minimum and maximum) of azimuth angles for each NT-TRP 172 so as to help filtering the interference in the azimuth dimension. Establishing the range of azimuth angles may involve use of angular-specific feedback received, directly or indirectly, from UEs 110. The BBU 182 may transmit (908), to the NT-TRPs 172A, 172B, indications of the configured elevation angle range and the configured azimuth angle range. When the UE 110 is an aerial UE, the BBU 182 may also transmit (908) indications of UE-specific configured elevation angle range and UE-specific configured azimuth angle range.

Responsive to receiving location-specific configurations, the first NT-TRP 172A may adjust (step 910) its own location so as to maintain the elevation angle in the configured elevation angle range and maintain the azimuth angle in the configured azimuth angle range. In conjunction with adjusting (step 910) its own location, the first NT-TRP 172A may signal (step 912), to the aerial UE 110, an updated beam alignment direction.

In those cases wherein one or both of the elevation angle and the azimuth angle cannot be maintained in the configured range (e.g., because of the first NT-TRP 172A reaching a maximum permissible altitude), the first NT-TRP 172A may transmit (914) an indication to inform the BBU 182 that one or both of the elevation angle and the azimuth angle cannot be maintained in the configured range while serving the UE 110. Alternatively, an aerial UE 110 may determine that one or both of the elevation angle and the azimuth angle cannot be maintained in a configured range. Responsive to receiving the indication, the BBU 182 may take an appropriate measure. One example of an appropriate measure involves updating a resource allocation. Another example of an appropriate measure involves updating the serving TRP 170/172, that is, switching the task of serving the particular UE 110 from the first NT-TRP 172A to the second NT-TRP 172B. Such switching may involve signaling (916) the UE 110 with instructions to communicate (918) with the second NT-TRP 172B.

According to aspects of the present application, the BBU 182 may configure NT-TRPs 172 to maintain a “minimum elevation angle” with respect to a certain reference point to, thereby, alleviate a Remote Interference Problem (RIP).

In particular, it is known that a downlink transmission from a TRP 170/172 can cause interference at a remote TRP 170/172 because of “atmospheric ducting”. Atmospheric ducting may be shown to occur when the beam alignment direction, on which the downlink transmission is carried, is oriented near the horizon. By maintaining, at an aerial UE 110, a minimum elevation angle with respect to a serving TRP 170/172, the RIP may be alleviated. For an NT-TRP 172, maintaining a minimum elevation angle with respect to specific UEs 110 may be shown to help to address the RIP. The specific UEs 110 may be the UEs 110 that are farthest from the NT-TRP 172.

The NT-TRP 172 may then maintain the configured minimum elevation angle by adaptively self-adjusting its location. The location of the NT-TRP 172 may be defined to include altitude and/or two-dimensional co-ordinates.

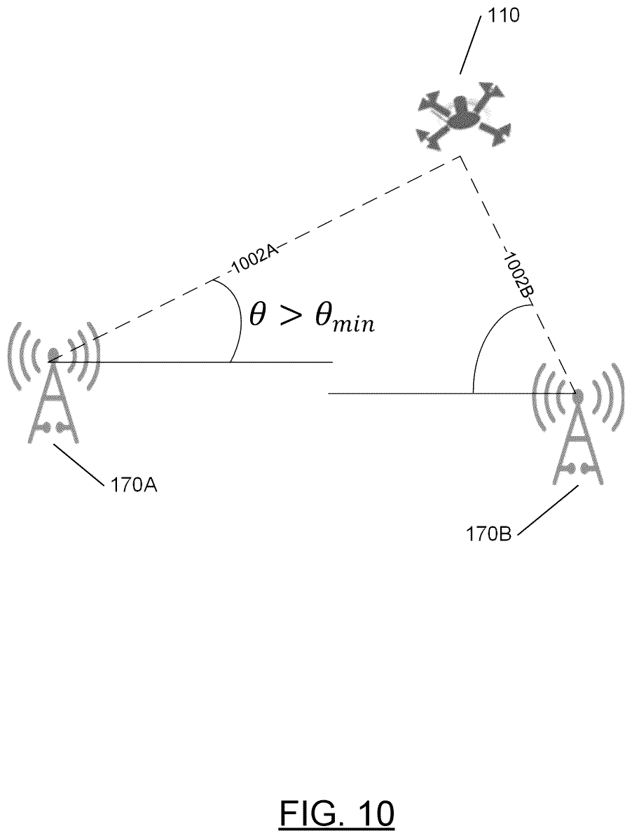

FIG. 10 illustrates a scenario with an aerial UE 110, a first T-TRP 170A and a second T-TRP 170B. A first beam alignment direction 1002A is illustrated between the aerial UE 110 and the first T-TRP 172A. A second beam alignment direction 1002B is illustrated between the aerial UE 110 and the second T-TRP 172B.

According to aspects of the present application, the BBU 182 (not illustrated in FIG. 10) may coordinate switching of the aerial UE 110 from the first T-TRP 170A to the second T-TRP 170B. The switching may be triggered following feedback, received at the BBU 182 from the aerial UE 110. The switching may be triggered responsive to the BBU 182 receiving an indication that the aerial UE 110 is unable to maintain, in the desired range, the elevation angle, θ, of the first beam alignment direction 1002A. The inability to maintain the elevation angle, θ, in the desired range may, for one example, be due to the altitude of the aerial UE 110 reaching a maximum. The inability to maintain the elevation angle, θ, in the desired range may, for another example, be due to other restrictions, such as the aerial UE 110 reaching a maximum in a range that is distinct from the altitude.

According to aspects of the present application, angular-specific measurements, included in feedback from the UEs 110, may be used, by an NT-TRP 172, to self-adjust the location of the NT-TRP 172. The self-adjustment of the location of the NT-TRP 172 may be shown to assist in maximizing spatial multiplexing gain in the network 100.

In practice, a UE 110 can separate signals received from two or more TRPs 170/172 under a condition that there is sufficient angular separation between the received signals at the UE 110.

It has been discussed hereinbefore that a UE 110 may signal, to an NT-TRP 172, a desired change in beam alignment direction. According to aspects of the present application, the UE 110 may signal, along with the desired change, an indication of a desired angular separation.

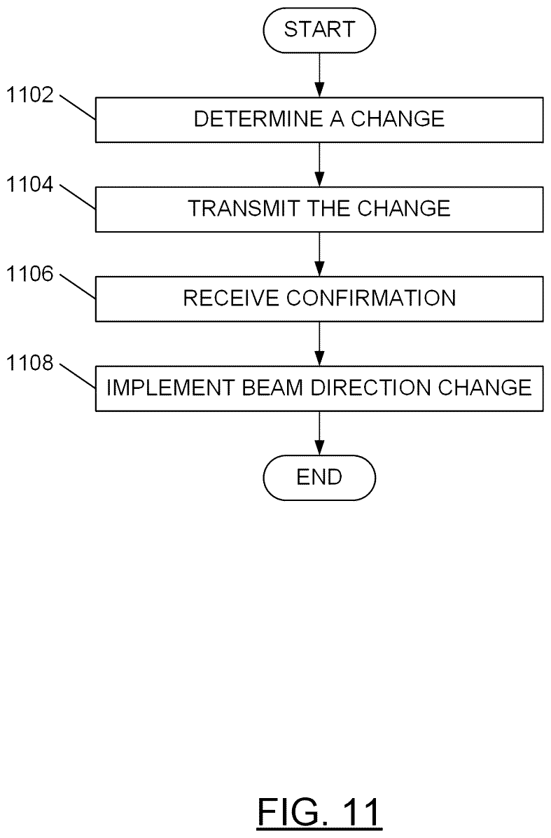

FIG. 11 illustrates example steps in a method, carried out at a UE 110, of causing changes in beam alignment direction. Initially, the UE 110 may determine (step 1102) a required change to the beam alignment directions. The UE 110 may then transmit (step 1104) the required change. The UE 110 may subsequently receive (step 1106) a confirmation of the beam alignment direction change. More specifically, the UE 110 may determine (step 1102), with respect to each NT-TRP 172 among a plurality of NT-TRPs 172, a change to respective beam alignment directions. The goal of the change to respective beam alignment directions may be shown to provide the UE 110 with an opportunity to spatially filter beams received, at the same time, from multiple TRPs 170/172. Upon completing the determining (step 1102) the change, the UE 110 may then signal (step 1104), to each NT-TRP 172 in the plurality of NT-TRPs 172, the change to the beam alignment direction.

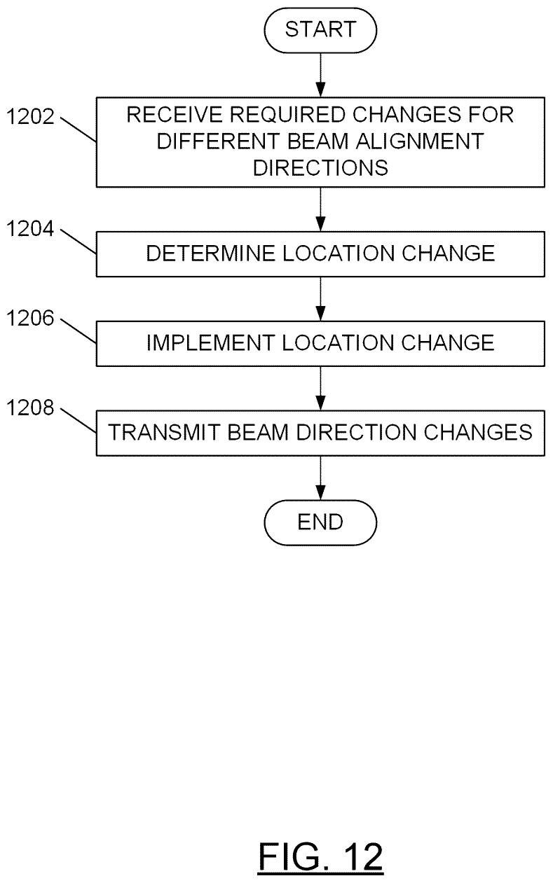

FIG. 12 illustrates examples steps in a method, carried out at a particular NT-TRP 172, of implementing changes in beam alignment direction.

Upon receiving (step 1202), at the particular NT-TRP 172 and from a plurality of different UEs 110, an indication of the required changes for different beam alignment directions, the indication of the required changes may be used to determine (step 1204) a change to the location of the particular NT-TRP 172. In conjunction with implementing (step 1206) the change to the location, the particular NT-TRP 172 may signal (step 1208), to each UE 110 in the plurality of different UEs 110, a respective updated beam alignment direction.

Returning to FIG. 11, the UE 110 may receive (step 1106), from the particular NT-TRP 172, an indication of the updated beam alignment direction, which may be considered to be a confirmation of the change. The UE 110 may then implement (step 1108) the updated beam alignment direction.

According to aspects of the present application, angular-specific measurements, included in feedback from UEs 110, may be used by the BBU 182 when deciding upon an on-demand deployment of an NT-TRP 172. An NT-TRP 172 may, for example, be deployed in an on-demand manner to serve UEs 110 in a region that experiences a sudden demand. Such an on-demand deployment of an NT-TRP 172 may be configured to optimize a spatial multiplexing gain.

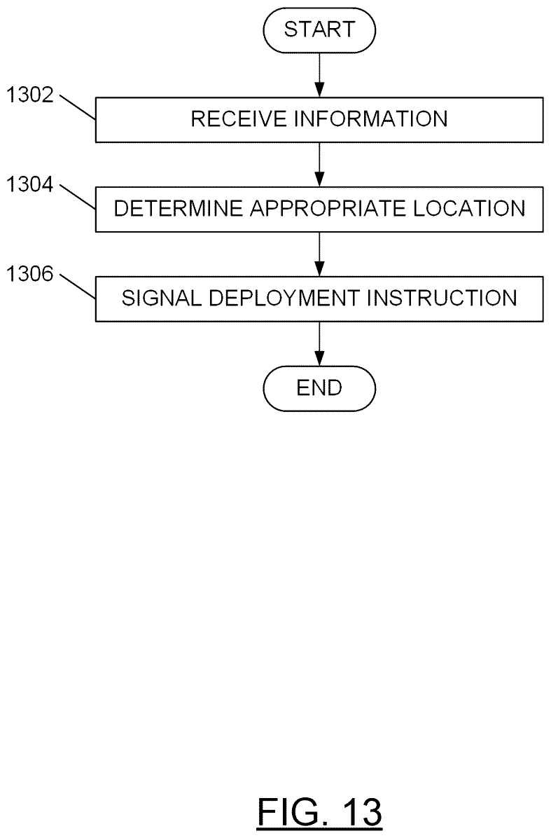

FIG. 13 illustrates example steps in a method of handling, at the BBU 182, an increase in demand for TRP services using on-demand deployment of an NT-TRP 172.

According to aspects of the present application, each UE 110 in the region signals information to the BBU 182.

For a particular UE 110, the information may, for example, include an indication of angular separation desired for decoding signals that are received, at the particular UE 110, from different directions.

For a particular UE 110, the information may, for example, include an indication of the beam alignment direction associated with signals received, at the particular UE 110, from currently serving TRPs 170/172 and/or from nearby TRPs 170/172.

For a particular UE 110, the information may, for example, include an indication of a range of beam alignment directions associated with interference levels that have been observed, at the particular UE 110, to be lower than a threshold.

For a particular UE 110, the information may, for example, include an indication of a range of beam alignment directions, over which range the particular UE 110 cannot reliably receive a signal, e.g., because of a nearby barrier or because of a strong source of interference.

For a particular UE 110, the information may, for example, include an indication of a range of beam alignment directions, over which range the particular UE 110 cannot transmit a signal, e.g., because to transmit a signal in that range would violate a maximum permissible exposure constraint.

Upon receiving (step 1302) the information from the UEs 110, the BBU 182 may use the information to determine (step 1304) an appropriate location for on-demand deployment of an NT-TRP 172.

To determine (step 1304) the appropriate location, the BBU 182 may use “k-means clustering.” According to Wikipedia, k-means clustering is a method of vector quantization, originally from signal processing, that aims to partition n observations into k clusters in which each of the n observations belongs to the cluster with the nearest mean (cluster centers or cluster centroid), serving as a prototype of the cluster.

Using k-means clustering, the BBU 182 may locate a cluster centroid of receive beam alignment directions for the UEs 110 in the region, which UEs 110 are currently being served by already deployed TRPs 170/172.

The BBU 182 may determine (step 1304) the appropriate location by determining a location at which a distance from already deployed TRPs 170/172 is maximized. The appropriate location may, for example, be found at an intersection of various ranges of interference-free beam alignment directions, reported by the UEs 110.

Upon determining (step 1304) the appropriate location, the BBU 182 may signal (step 1306), to an as-yet-not-deployed NT-TRP 172, a deployment instruction that includes an indication of the location determined in step 1304.

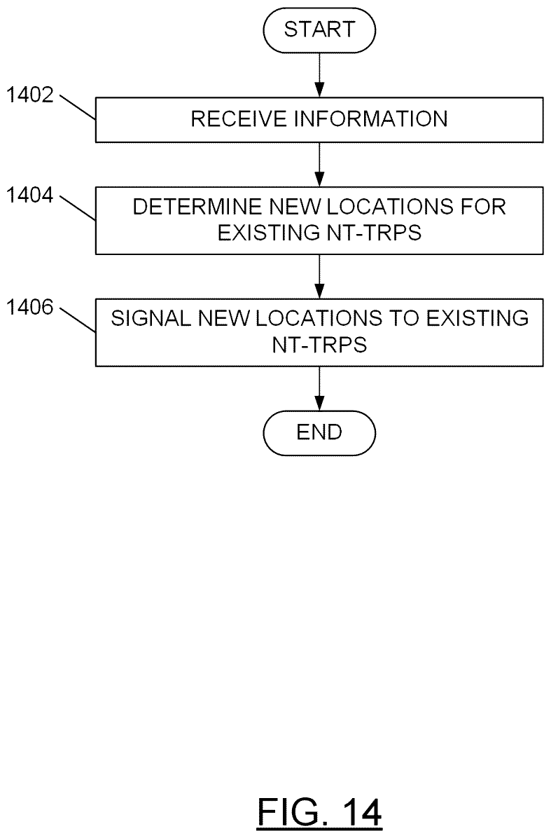

FIG. 14 illustrates example steps in a method of handing an increase in demand for TRP services as an alternative to the method illustrated in FIG. 13.

Upon receiving (step 1402) the information from the UEs 110, the BBU 182 may use the information to determine (step 1404) new locations for the already deployed NT-TRPs 172. One of the goals of determining (step 1404) the new locations may be to maximize spatial multiplexing gain. The BBU 182 may then signal (step 1406), to the already deployed NT-TRPs 172, indications of their respective new locations.

It should be appreciated that one or more steps of the embodiment methods provided herein may be performed by corresponding units or modules. For example, data may be transmitted by a transmitting unit or a transmitting module. Data may be received by a receiving unit or a receiving module. Data may be processed by a processing unit or a processing module. The respective units/modules may be hardware, software, or a combination thereof. For instance, one or more of the units/modules may be an integrated circuit, such as field programmable gate arrays (FPGAs) or application-specific integrated circuits (ASICs). It will be appreciated that where the modules are software, they may be retrieved by a processor, in whole or part as needed, individually or together for processing, in single or multiple instances as required, and that the modules themselves may include instructions for further deployment and instantiation.

Although a combination of features is shown in the illustrated embodiments, not all of them need to be combined to realize the benefits of various embodiments of this disclosure. In other words, a system or method designed according to an embodiment of this disclosure will not necessarily include all of the features shown in any one of the Figures or all of the portions schematically shown in the Figures. Moreover, selected features of one example embodiment may be combined with selected features of other example embodiments.

Although this disclosure has been described with reference to illustrative embodiments, this description is not intended to be construed in a limiting sense. Various modifications and combinations of the illustrative embodiments, as well as other embodiments of the disclosure, will be apparent to persons skilled in the art upon reference to the description. It is therefore intended that the appended claims encompass any such modifications or embodiments.

1. A method comprising:
receiving, at an aerial node from a first communication device, information specific to the first communication device;
adjusting a location of the aerial node to a new location determined based, at least in part, on the information; and
transmitting, to the first communication device, an indication of a new beam alignment direction, the new beam alignment direction determined based on the new location of the aerial node.

2. The method of claim 1, wherein the information indicates a feature specific to the first communication device.

3. The method of claim 2, wherein the feature relates to an antenna array structure.

4. The method of claim 1, wherein the information indicates a measurement made at the first communication device.

5. The method of claim 1, further comprising:
configuring each communication device of a plurality of communication devices, wherein the plurality of communication devices includes the first communication device;
receiving, from the each communication device, corresponding information specific to the each communication device; and
transmitting, to the each communication device, a corresponding angular-specific configuration determined based on the corresponding information specific to the each communication device.

6. The method of claim 5, wherein the each communication device comprises a corresponding transmit receive point.

7. The method of claim 5, wherein the each communication device comprises a corresponding user equipment.

8. The method of claim 5, wherein the corresponding angular-specific configuration comprises a range including a minimum elevation angle and a maximum elevation angle.

9. The method of claim 8, wherein the minimum elevation angle and the maximum elevation angle comprise elevation angles.

10. The method of claim 9, wherein the minimum elevation angle is determined in a manner that obviates a remote interference problem.

11. The method of claim 9, wherein the maximum elevation angle is determined in a manner that mitigates interference with terrestrial nodes.

12. The method of claim 9, wherein:
the corresponding information specific to the each communication device indicates an angular separation desired at the each communication device; and
the maximum elevation angle is determined in a manner that maintains the angular separation at the each communication device.

13. The method of claim 8, wherein the minimum elevation angle and the maximum elevation angle comprise azimuth angles.

14. The method of claim 8, further comprising:
receiving, from a communication device among the plurality of communication devices, an indication that an angle cannot be maintained within the range; and
transmitting, to the communication device, an instruction to switch from communicating with a second communication device to communicating with a third communication device.

15. A method comprising:
Transmitting, to an aerial node, information specific to a first communication device, wherein the information is used to determine a new location of the aerial node; and
receiving, an indication of a new beam alignment direction, the new beam alignment direction determined based on the new location of the aerial node.

16. The method of claim 15, wherein the information indicates a feature specific to the first communication device.

17. The method of claim 16, wherein the feature relates to an antenna array structure.

18. The method of claim 15, wherein the information indicates a measurement made at the first communication device.

19. An apparatus comprising:
one or more processors in communication with a non-transitory storage medium storing instructions, wherein execution of instructions by the one or more processors causes the apparatus to perform:
receiving, from a first communication device, information specific to the first communication device;
adjusting a location of the apparatus to a new location determined based, at least in part, on the information; and
transmitting, to the first communication device, an indication of a new beam alignment direction, the new beam alignment direction determined based on the new location of the apparatus.

20. The apparatus of claim 19, wherein the information indicates a feature specific to the first communication device.
